(19) United States
(12) Patent Application Publication
(10) Pub. No.: US 2018/0108204 A1
(43) Pub. Date: Apr. 19, 2018

(54) Automatic Vending Machine Having Air Cushion Packaging Apparatus, Monitoring System Thereof, and Method Therefor

(71) Applicant: Shanghai Air-Paq Composite Material Co., Ltd., Shanghai (CN)

(72) Inventor: Jiaying ZHANG, Shanghai (CN)

(73) Assignee: Shanghai Air-Paq Composite Material Co., Ltd., Shanghai (CN)

(21) Appl. No.: 15/528,096

(22) PCT Filed: Nov. 18, 2015
(86) PCT No.: PCT/CN2015/094895

§ 371 Date: Sep. 12, 2017

(30) Foreign Application Priority Data
Nov. 21, 2014 (CN) 201410673714.9
Feb. 4, 2015 (CN) 201510058490.5
Aug. 27, 2015 (CN) 20150535341.3
Sep. 29, 2015 (CN) 201510629731.7

(51) Int. Cl. G07F 11/00; B65D 81/03

(52) U.S. Cl. CPC G07F 11/00; B65D 81/03

(57) ABSTRACT

A vending device of air bag packaging arrangement and its monitoring system and method, wherein the device comprise a storage unit for storing the air bag packaging arrangement; a controlling unit which comprises a selection module, a payment module and a processor, and the selection module and the payment module are operatively connected with the processor, wherein the selection module is used to assistant to select types of the air bag packaging arrangement, wherein the payment module is used to assistant to complete the payment of the selected air bag packaging arrangement; and an allocation unit operatively connected with the processor and provides the air bag packaging arrangement which is selected and paid to buyer under controlling of the processor.

### CROSS REFERENCE OF RELATED APPLICATION

This is a U.S. National Stage under 35 U.S.C. 371 of the International Application Number PCT/CN2015/094895, filed Nov. 18, 2015, which claims priority under 35 U.S.C. 119(a-d) to Chinese application numbers 201410673714.9, filed Nov. 21, 2014, 201510058490.5, filed Feb. 4, 2015, 201510535341.3, filed Aug. 27, 2015, and 201510629731.7, filed Sep. 29, 2015. The afore-mentioned patent applications are hereby incorporated by reference in their entireties.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to an vending device of air bag packaging arrangement, and more particularly to an vending device of air bag packaging arrangement and its monitoring system and method, which coordinates with the retail to realize an automatically vending of the air packing, wherein the vending device is adapted for providing the air bag packaging to common consumers.

### Description of Related Arts

The air bag packaging arrangement, represented by the air packaging bag, supports a bag body to form a buffering protection structure by filling the gas such as air into a closed cavity which is formed by the bag body. The air packaging bag realizes the purpose of using the gas such as air as buffering materials to pack products. Especially, in recent years, with the rapid development of the electronic commerce and the logistics transportation, comparing with the traditional packaging method which uses the foam to pack the products, the air bag packing arrangement receives more and more popularity and favor from the market for its advantages of low cost, better packaging effect and less occupying storage room.

At present, the popular packaging bags in the retail market are mainly the ones which are made of the plastic or paper materials, which not only have a high cost but also cause pollution to the environment easily, and the most important aspects are that such packaging bags are formed by one single layer material which only provided a function of packaging but can't provide the function of protection. In other words, such packaging bag can only allow users to put products therein for convenient carriage, but when the packaging bag, which is filled with the product, touches the ground or other hard objects, the product in the packaging bag is very easily damaged, especially when fragile objects such as eggs, bottle wine are filled therein. But the air bag packaging arrangement is commonly made by two layer materials which are overlapped with each other, and users can inflate gas into the cavity which is formed by the two layer materials so as to provide a corresponding buffering function. When the fragile products such as eggs and the bottle wine are disposed into the air bag packing arrangement, even the air bag packaging arrangement touches the ground or other hard objects, the fragile products filled therein are not damaged. So that, in the view of the effect of the air bag packaging arrangement, the air bag packaging arrangement access into the retail market and become popular in the retail market shall become a necessary trend. However, for that the air bag packaging arrangement must be inflated with the gas before using, the air pump must be used to complete the charging operation, which leads to that the traditional commercial mode of the air bag packaging arrangement is provided to the medium-sized manufactures and logistics industry and the air bag packaging arrangement is hardly provided to the common consumers.

The present invention aims to provide a service that provides the air bag packaging arrangement to the common consumers so that bring the air bag packaging arrangement from the traditional market into the retail market, and seriously reduce its vending price so as to conform to the future development trend of the air bag packaging arrangement.

With the constant development of the logistics industry, various products shall be through the logistics transportation into each big market and consumer. During the process of the logistics transportation, a packaging of the product is especially important. A good packaging manner shall effectively protect the product packaged therein safely.

At present, the air bag packaging arrangement, which is used more frequently, is formed by two thin films and at least an inflation valve through the heat-sealing way, wherein when the air bag packaging arrangement is used, the gas pump or other pump device is used to inflate gas for it so that the gas bag packaging arrangement has a buffering function which shall effectively prevent products packaged therein from being extruded and collided during the process of transportation of storage. Except that, the air bag packaging arrangement can be designed into a variety of shapes so as to be adapted for various products which have different shapes, which not only protect the products but also enhance the beauty. Except that, when the air bag packaging arrangement is in the unused state, it can't be inflated with the gas and be rolled up which will save the occupying room. Especially for the fragile products, for example, chemicals, wine, drinks, milk, telephone, and other electronic products, if they are extruded and crashed, they are easily damaged which shall cause serious damages for merchants and consumers. But if using the air bag packaging arrangement to package the products, they shall be protected effectively and be conveniently carried around. So, application fields of the air bag packaging arrangement are more and more widely.

For many logistics companies and industries, for the reason that there are lots of goods are transported out, workers need to package every good using the corresponding air bag packaging arrangement and to inflate them with gas, which shall bring too much work and low working efficiency. For example, for the logistics company, it need different products with different standard, variety, size, and shape, so that they have to choose different air bag packaging arrangement, manually choose, which is a tedious work for workers and the efficiency of packaging is very low. So, since the logistics companies have considerable business every day, in order to enhance the efficiency of packaging, they have to hire more workers to participate in the packaging, which shall increase the labor costs. For the factories, after products are produced, they need choose corresponding air bag packaging arrangements to package products, so that for workers that on the production lines, they have to repeat the same manners every day, which are not only dull for them but their working efficiency is very low. Especially the online shopping is very popular at present, every shopping platform sell majority of products every day, and these products shall be through being transferred and transported to reach hands of consumers. So, these various products need to being incorporated with corresponding air bag packaging arrangement and can be transported, which sets high demands for merchants. In a word, methods of using the air bag packaging arrangement to package products have some difficult packaging problems, such as low packaging speed, low packaging efficiency and high labor costs.

Therefore, it is urgent to solve the packaging problems for the logistics companies and factories to meet the developing needs of product packages to become more automatically and more humanizedly.

The packaging bags are broadly applied in people's lives and industries, whether retail market shopping, electronic commerce, factory shipments or logistics transportation, all of which need to use variously different packaging bags. Now, the popular packaging bags in the retail market are mainly the ones which are made of the plastic or paper materials, and such packaging bags are formed by one single layer material which only provided a function of packaging but can't provide protection for the products packaged therein. Hence, when the packaging bag, which is filled with the products, touches the ground or other hard objects, these products in the packaging bag are very easily damaged, especially when these products are fragile objects such as eggs, bottle wine and so on. Therefore, in the electronic commerce, product shipment and logistics transportation, proprietors have given up traditional packaging bags, and change to use the fluid packaging bags which both have effects of packaging products therein and protecting products therein, and have low costs, wherein when products are shipped out or transported, all of them have been packaged by fluid packaging bags and until these produces are delivered to receivers and their packaging bags are removed, these products are not easily damaged.

Traditional fluid packaging bags are made by two-layer materials which are overlapped with each other and cavity which is formed by the two-layer materials is able to be inflated with air, inert gas, water of other fluid to provide corresponding buffering function, wherein when fragile products such as eggs, bottle wine are packaged in the fluid bag packaging arrangement, even though the fluid bag packaging arrangement touches the ground or other hard objects, it will not cause damage to products which are packaged therein. However, for that the fluid bag packaging arrangement must be inflated with the fluid before being used, the fluid pump must be used to complete the charging operation, which leads to that the traditional commercial mode of the fluid bag packaging arrangement is to provide the fluid bag packaging arrangement to the medium-sized manufactures and logistics industry and the fluid bag packaging arrangement is hardly provided to the common consumers. Except that, the traditional fluid bag packaging arrangement commonly use the above two-layer structure as a plane to simply package, package or pad products which are ready for being packaged, even use other packaging materials such as paper box to assistant the package, or simply form an envelope-shaped bag through self-pasted opening way to package products, styles of which are few, which will probably cause the using rang being limited, even for the reason that they need other packaging materials to assistant the package, which may increase the costs, and even more enhance the extra burden to environment.

In order to improve the above problems, inventors have invented a variety of fluid bag packaging arrangements for many products which have different shapes, sizes and characteristic, and many a variety of platform devices which provide and assistantly utilize various fluid bag packaging arrangements. For example, an vending device of air bag packaging arrangement, which is able to be set in supermarket, shopping mall, scenic spots, even logistics hubs and other public occasions, allows common consumers to choose different fluid bag packaging arrangement having different type, shape , size and so on conveniently, and assists to fill the fluid bag packaging arrangement, so as to meet the need of personalized or actual package of shopping. For example, it is able to be used in workstations which are set in logistics companies, factories, large commercial firms, boutique commercial firms and other special occasions, wherein it allows users such as staffs and consumers to choose or automatically get the fluid bag packaging arrangement which is matched with products that are ready for being packaged, and assist users to fill the fluid into the fluid bag packaging arrangement to package products which need to be packaged.

However, with types of the fluid bag packaging arrangement which are provided by the offering platform and every other platform, getting more and more diversified, in order to effectively manage every offering platform and master more merchant information, monitoring systems and methods of the present invention are needed to collect and analyze real-time or semi real time data and provide them to managers so as to make platform operators are able to make ideal and accurate reacts according to them and even adjust operational tactical strategies to gain more operational advantages. Take a step back, operators of the offering platform are also able to sell or share part or all data which are collected and analyzed by the monitoring system and method of the present invention based on alliances to gains benefits. It is worth to mention that, the monitoring system and method of the present invention is also able to accord to the operator's setting to automatically execute daily matters except to utilize the collecting data to assist the operator to manage the operational tactical strategies. For example, when acquiring devices get stocking data of various fluid bag packaging arrangements disposed in each offering platform, which are transited from offering platform of the fluid bag packaging arrangement, after automatically determining, they shall send information or commands to remind or request back offices going to supply a certain number of the fluid bag packaging arrangement of certain type. Except that, when receiving fault messages transmitted from the certain offering platform of the fluid bag packaging arrangement, or not receiving information from the certain offering platform of the fluid bag packaging arrangement after a certain time, it shall inform maintenance department, a third party, staffs of signed merchant to repair or check them.

Except that, different from the traditional packaging bags which are only able to provide single function, the present fluid bag packaging arrangements have developed many different types and application, wherein some fluid bag packaging arrangements have positioning device disposed therein to prevent theft and trackers, or some have temperature sensor disposed therein to avoid products packaged therein from corroding by high temperature, or some have RFID disposed therein to record whether products pass through or reach specific locations. In order to manage so many fluid bag packaging arrangements in real time, the monitoring system and method of the present invention further incorporate with each sensor device, for that it is able to receive information from each sensor device to respond immediately and have more comprehensive data collection capability. For instance, when the monitoring system of the present invention detect that the internal temperature of the packaging arrangement is too high through the temperature sensor disposed in the certain fluid bag packaging arrangement, it is able to remote the packaging arrangement to send alarming signal, to contact persons holding the packaging arrangement, or immediately contact persons who sell or buy products that are packaged in the packaging arrangement, so as to avoid products packaged therein spoiling for the high temperature, and also help the buyer and seller to assign duties that bring by the spoiling products. Except that, through the positioning device disposed in the certain fluid bag packaging arrangement, the monitoring system is able to trace the path that the packaging arrangement leave the offering platform, so that the present invention not only let the people such as the buyer, the seller, who have related authority find the left products and catch the thief by lining the monitoring system through the path traced by the monitoring system when products are lost or stolen, and furtherly according to the majority of these path records, it proposes reference data with trading value, such that boutique buyers whether hanging in the shopping mall after they complete purchase and what kind of shopping they like hanging around, to provide them to platform operators and their operational companies, or customs for reference.

Most importantly, the fluid bag packaging arrangement breaks the characters of the traditional packaging bag as a transitional, disposable and common container, to provide users with extra and adding choice when they purchase, sell and transport the main products, in other words, the fluid bag packaging arrangement is more than a packaging bag. Its derived result is to make users have more chance to choose packaging bags with different shape, size, pattern, extra function and so on in the fluid bag packaging arrangement. In many occasions, these choices are involved different extra fees which further influences the user' choices data of which have great referring value for making operational strategies, so that the present invention provides a monitoring system adapted for collecting and analyzing these related data.

### SUMMARY OF THE PRESENT INVENTION

The invention is advantageous in that it provides a vending device and its monitoring system and method of air bag packaging arrangement, wherein said vending device adapted for providing said air bag packaging arrangement to common consumer.

Another advantage of the invention is to provide a vending device and its monitoring system and method of air bag packaging arrangement, wherein said vending device is used to introduce said air bag packaging arrangement from the traditional market in the retail market, and shall not increase costs and prices of said air bag packaging arrangement, such that said vending device is adapted for being equipped in public occasions such as super market, shopping mall to provide convenience for consumers' using.

Another advantage of the invention is to provide a vending device and its monitoring system and method of air bag packaging arrangement, wherein said vending device allows common consumers to conveniently choose said air bag packaging arrangement with different size, shape, type and so on so as to meet personalized needs of common consumers.

Another advantage of the invention is to provide an vending device and its monitoring system and method of air bag packaging arrangement, wherein said vending device is able to provide various means of payment to allow common consumers can use the existing means of payment such as cash payment, the third party payment, which have been used to complete the payment so as to provide convenience.

Another advantage of the invention is to provide a vending device and its monitoring system and method of air bag packaging arrangement, wherein said vending device is able to accord to the information that consumers put in, such as manual input, or input by scanning purchasing list, to automatically provide common consumers with said air bag packaging arrangement which is matched with the purchased products which is easily operated.

Another advantage of the invention is to provide a vending device and its monitoring system and method of air bag packaging arrangement, wherein said vending device provides a displaying module which shall display said selected air bag packaging arrangements in inflating state in image form for common consumers to confirm.

Another advantage of the invention is to provide a vending device and its monitoring system and method of air bag packaging arrangement, wherein said vending device is able to incorporate with the cash register or the packaging register so that common consumers can directly get said air bag packaging arrangement which is matched with products they have purchased after they finish their shopping.

Another advantage of the invention is to provide a vending device and its monitoring system and method of air bag packaging arrangement, wherein when said air bag packaging arrangement is selected by said common consumers and after said common consumers have finished the payment, said inflating device is able to inflate said air bag packaging arrangement so that said common consumers can get said air bag packaging arrangement which have been inflated.

Another advantage of the invention is to provide a vending device and its monitoring system and method of air bag packaging arrangement, wherein said vending device is easily operated, conveniently used and adapted for being promoted and popularized in large scale.

Another advantage of the invention is to provide a working station and its method of air bag packaging arrangement, wherein said working station is adapted for being utilized in logistics companies, factories, or large shopping malls to effectively increase the efficiency of the packaging speed and efficiency.

Another advantage of the invention is to provide a working station and its method of air bag packaging arrangement, wherein said working station is able to provide said corresponding air bag packaging arrangement according to size and shape of said products to package said products.

Another advantage of the invention is to provide a working station and its method of air bag packaging arrangement, wherein said working station is able to automatically provide matched said air bag packaging arrangement to workers through scanning product lists so as to make said workers package said products conveniently and easily.

Another advantage of the invention is to provide a working station and its method of air bag packaging arrangement, which provides a scanning module which is able to match said corresponding air bag packaging arrangement with said products through scanning corresponding product lists or shipping lists of products that shall be packaged, and then packaging and inflate said products automatically.

Another advantage of the invention is to provide a working station and its method of air bag packaging arrangement, wherein choice, package, and inflation of said air bag packaging arrangement are combined in a body to realize assembly line work and automatic operation to accord trends of product package.

Another advantage of the invention is to provide a working station and its method of air bag packaging arrangement, wherein said working station is incorporated with shipment machine, wherein said shipment machines transport products to said working station and ship said products after said products are packaged automatically so as to meet needs of product package of manufacturing industry.

Another advantage of the invention is to provide a working station and its method of air bag packaging arrangement, wherein said working station comprises a voice module, wherein when said working station is out of stock or completes product package, or is out of work, it shall send different sounds to alert operators, and it is also able to realize voice interaction to let workers make corresponding settings through voice.

Another advantage of the invention is to provide a working station and its method of air bag packaging arrangement, which is able to complete majority of product packages by said workers operating said working station so as to change the traditional packaging manner and effectively save labor packaging costs for industries.

Another advantage of the invention is to provide a working station and its method of air bag packaging arrangement, which changes the packaging manner form the traditional manual packaging manner to the automatic packaging manner so as to be consistent with the future development trend.

Another advantage of the invention is to provide a working station and its method of air bag packaging arrangement, which has advantages of easy operation, simple packaging process and convenient utilization, and is suitable for being promoted and popularized in a large scale.

Another advantage of the invention is to provide a monitoring system and a method of an offering platform of said fluid bag packaging arrangement, wherein said monitoring system of said fluid bag packaging arrangement is able to store, collect, put out, and receive related information from said offering platform of said fluid bag packaging arrangement.

Another advantage of the invention is to provide a monitoring system and a method of an offering platform of said fluid bag packaging arrangement, wherein said fluid bag packaging arrangement has more than one type and size.

Another advantage of the invention is to provide a monitoring system and a method of an offering platform of said fluid bag packaging arrangement, wherein said fluid bag packaging arrangement has a sensor to monitor a state of the packaging products.

Another advantage of the invention is to provide a monitoring system and a method of an offering platform of said fluid bag packaging arrangement, wherein said fluid bag packaging arrangement has a sensor to monitor locations of the packaging products.

Another advantage of the invention is to provide a monitoring system and a method of an offering platform of said fluid bag packaging arrangement, wherein said fluid bag packaging arrangement has a sensor to monitor environment around the packaging products.

Another advantage of the invention is to provide a monitoring system and a method of an offering platform of said fluid bag packaging arrangement, wherein said sensor is able to send information in order to achieve the goal of remote monitoring.

Another advantage of the invention is to provide a monitoring system and a method of an offering platform of said fluid bag packaging arrangement, wherein said sensor is able to send and receive information bidirectionally.

Another advantage of the invention is to provide a monitoring system and a method of an offering platform of said fluid bag packaging arrangement, wherein said monitoring system of said offering platform of said fluid bag packaging arrangement is able to communicate with one or more fluid bag packaging arrangement to receive the information from said fluid bag packaging arrangement.

Another advantage of the invention is to provide a monitoring system and a method of an offering platform of said fluid bag packaging arrangement, wherein said monitoring system of said offering platform of said fluid bag packaging arrangement is able to store, collect, put out and receive related information form said fluid bag packaging arrangement.

Another advantage of the invention is to provide a monitoring system and a method of an offering platform of said fluid bag packaging arrangement, wherein said monitoring system of said offering platform of said fluid bag packaging arrangement is able to receive commands and information form internet, telecommunication network and other resource.

Another advantage of the invention is to provide a monitoring system and a method of an offering platform of said fluid bag packaging arrangement, wherein said monitoring system of said offering platform of said fluid bag packaging arrangement is able to receive and store the input and output of the proximal information and remote information.

Another advantage of the invention is to provide a monitoring system and a method of an offering platform of said fluid bag packaging arrangement, wherein said monitoring system of said offering platform of said fluid bag packaging arrangement is able to communicate one or more said offering platform of said fluid bag packaging arrangement to send information or commands to certain or all said offering platform of said fluid bag packaging arrangement

Another advantage of the invention is to provide a monitoring system and a method of an offering platform of said fluid bag packaging arrangement, wherein said monitoring system of said offering platform of said fluid bag packaging arrangement is totally or simultaneously operated by one or more said offering platform of said fluid bag packaging arrangement.

Another advantage of the invention is to provide a monitoring system and a method of an offering platform of said fluid bag packaging arrangement, which is able to communicate one or more said fluid bag packaging arrangement to send information or commands to certain or all said fluid bag packaging arrangement.

Another advantage of the invention is to provide a monitoring system and a method of an offering platform of said fluid bag packaging arrangement, which is able to crossly utilize information which have been stored or is received in real time to collect and analyze data and generate commands and Information.

Another advantage of the invention is to provide a monitoring system and a method of an offering platform of said fluid bag packaging arrangement, which makes services of selecting and starting extend to the subsequent various trace and alert.

Another advantage of the invention is to provide a monitoring system and a method of an offering platform of said fluid bag packaging arrangement, wherein two or more of said monitoring systems of said offering platform of said fluid bag packaging arrangement are able to work simultaneously.

Another advantage of the invention is to provide a monitoring system and a method of an offering platform of said fluid bag packaging arrangement, wherein two or more of said monitoring systems of said offering platform of said fluid bag packaging arrangement depend with each other.

Another advantage of the invention is to provide a monitoring system and a method of an offering platform of said fluid bag packaging arrangement, wherein said monitoring system of said offering platform of said fluid bag packaging arrangement is able to be incorporated in said offering platform of said fluid bag packaging arrangement.

Another advantage of the invention is to provide a monitoring system and a method of an offering platform of said fluid bag packaging arrangement, wherein said monitoring system of said offering platform of said fluid bag packaging arrangement has multiple access authority to provide to system owner, signed factories, logistics maintenance firms, common consumers, and common people to store information of different range.

In order to achieve the above mentioned objects, according to the present invention, the foregoing and other objects and advantages are attained by a, comprising: a storage unit for storing said air bag packaging arrangement; a controlling unit which comprises a selection module, a payment module and a processor, wherein said selection module and said payment module are operatively connected with said processor, wherein said selection module is adapted for assisting to select types of said air bag packaging arrangement, and said payment module is adapted for assisting a payment of said selected air bag packaging arrangement; and an allocation unit operatively connected with said processor and providing said air bag packaging arrangement which is selected and paid to buyers under a controlling of said processor.

According to an embodiment of the present invention, wherein the vending device of air bag packaging arrangement further comprises an inflating device for inflating said air bag packaging arrangement which is paid.

According to an embodiment of the present invention, wherein said inflating device is operatively connected with said processor to respond controlling commands of said processor and inflate said air bag packaging arrangement which is selected and paid.

According to an embodiment of the present invention, wherein said inflating device automatically completes an inflating operation of said air bag packaging arrangement which is selected and paid through controlling inflating time.

According to an embodiment of the present invention, wherein said controlling unit further comprises a displaying module which is operatively connected with said processor for providing said buyers with a displaying interface during operation.

According to an embodiment of the present invention, wherein said controlling unit further comprises a scanning module which is operatively connected with said processor.

According to an embodiment of the present invention, wherein said scanning module is used to scan a paying receipt so as to execute functions of said payment module to complete functions of confirming payment.

According to an embodiment of the present invention, wherein said scanning module is used to scan a shopping list of said buyers for said processor computing and matching said suitable air bag packaging arrangement according to products on said shopping list.

According to an embodiment of the present invention, wherein said scanning module is a three dimensional scanning device, which scans products purchased by said buyer in three-dimensional manner for said processor computing and matching said suitable air bag packaging arrangement for said products according to scanning information

According to an embodiment of the present invention, wherein said controlling unit further comprises a communicating module operatively connected with said processor to assistant to complete a function of a third-party payment, and after said payment being completed, said communicating module receives an information of confirming to pay from said third-party payment platform and transmits said payment information to said processor.

According to an embodiment of the present invention, wherein said payment module provides a scanning identity and said buyer use an electronic mobile device to scan said scanning identity so as to start payment function.

According to an embodiment of the present invention, wherein said controlling unit further comprises a voice module operatively connected with said processor to achieve voice interaction function with said buyers.

According to an embodiment of the present invention, wherein said selection module provides one or more input devices of buttons, input keyboards, touch screens, voice recognition input.

According to an embodiment of the present invention, wherein said payment module comprises a coin inlet portion and a coin outlet portion, and said payment module recognizes paper money or coins which are threw in said coin inlet portion to complete said payment and achieves a function of giving changes through said coin inlet portion.

According to an embodiment of the present invention, wherein said coin inlet portion has an individual coin outlet opening or has a coin outlet opening combined with a shipment opening.

According to an embodiment of the present invention, wherein said payment module comprises a card portion for said buyer completing payment by bank cards.

According to an embodiment of the present invention, wherein said air bag packaging arrangement has same or different types, and has same or different sizes.

According to an embodiment of the present invention, wherein said allocation unit further comprises a cutting portion to cut an air bag packaging continuum which forms said air bag packaging arrangement at a suitable portion to form said air bag packaging arrangement having suitable size and shape.

A method of automatically selling an air bag packaging arrangement through a vending machine, comprising the following steps: receiving a purchasing command from a buyer and assisting said buyer to completing selection of types and payment of said air bag packaging arrangement; and providing said selected and paid air bag packaging arrangement to said buyer through an allocation unit.

According to an embodiment of the present invention further comprises a step that inflating said selected and paid air bag packaging arrangement through an inflating device which is integrally disposed in said vending device.

According to an embodiment of the present invention further comprises a step that inflating said air bag packaging arrangement first and then packaging products with said inflated air bag packaging arrangement, or packaging products first with an air bag packaging arrangement which is not inflated and then inflating said air bag packaging arrangement.

According to an embodiment of the present invention comprises a step that inflating said various air bag packaging arrangement through controlling inflating time.

According to an embodiment of the present invention comprises a step that selectable types of said air bag packaging arrangement comprising one or more of selection of parameters of type, shape, and size of said air bag packaging arrangement.

According to an embodiment of the present invention comprises a step that: determining a touch operation of said buyer on a displaying module and said vending device completing selection of types of said air bag packaging arrangement.

According to an embodiment of the present invention, wherein comprises a step that: determining an operation of operating an button and said vending device completing selection of types of said air bag packaging arrangement.

According to an embodiment of the present invention, wherein comprises a step that: determining an input operation on an input keyboard and said vending device completing selection of types of said air bag packaging arrangement.

According to an embodiment of the present invention, wherein comprises a step that: recognizing an voice input of said buyers and said vending device completing selection of types of said air bag packaging arrangement.

According to an embodiment of the present invention, wherein comprises a step that: recognizing paper money and coins that said buyer threw in to complete a payment of said air bag packaging arrangement.

According to an embodiment of the present invention, wherein comprises a step that: determining an operation of swiping a bank card to complete a payment of said air bag packaging arrangement.

According to an embodiment of the present invention, wherein comprises a step that: recognizing paper money and coins that said buyer threw in to complete a payment of said all bag packaging arrangement.

According to an embodiment of the present invention, wherein comprises a step that: recognizing a paying receipt provided by said buyers and determining whether a payment operation of said air bag packaging arrangement is completed.

According to an embodiment of the present invention, wherein comprises a step that: receiving information of types and sizes of said products ready for being packaged that said buyer inputting, and after a computing and matching operation, providing preselecting programs of said air bag packaging arrangement used to package products ready for being packaged to said buyers for said buyer selecting, or after confirming said payment to be completed, directly providing said matched air bag packaging arrangement to said buyers.

According to an embodiment of the present invention, wherein comprises a step that: scanning said products ready for being packaged of said buyer in three-dimensional manner, and after a computing and matching operation, providing preselecting programs of said air bag packaging arrangement used to package products ready for being packaged to said buyers for said buyer selecting or after confirming said payment to be completed, directly providing said matched air bag packaging arrangement to said buyers.

According to an embodiment of the present invention, wherein comprises a step that: recognizing a shopping list that said buyer providing, and providing preselecting programs of said air bag packaging arrangement used to package products ready for being packaged to said buyers for said buyer selecting or after confirming said payment to be completed, directly providing said matched air bag packaging arrangement to said buyers.

According to an embodiment of the present invention, wherein said air bag packaging arrangement comprises two-layer air chamber films and two-layer valve films, wherein said two-layer air chamber films and said two-layer valve films are overlapped with each other to form a one-way valve for inflating one or more inflating units formed by said two-layer air chamber films.

According to an embodiment of the present invention, wherein said air bag packaging arrangement comprises an inflation cushion which functions as an inflation material to be filled in other packaging boxes, or packaging bags.

According to an embodiment of the present invention, wherein said air bag packaging arrangement comprises an air packaging bag having an accommodating chamber, which is formed by being folded up and heat sealed, wherein said products are adapted for being disposed in said accommodating chamber.

According to an embodiment of the present invention, wherein many of said air bag packaging arrangements further comprise a functional layer which is disposed inside or outside of a packaging body which is formed by said four films, wherein said function layer is fixedly connected with said packaging body and provides at least a function of shading, heat preservation, electrostatic prevention, waterproof, moisture proof, wear-resistant, anti-shock, anti-seismic, corrosion resisting, and printing.

According to an embodiment of the present invention, wherein many of said air bag packaging arrangements have paper packaging box which is disposed outside of said packaging body which is formed by said four films, wherein at least part of said packaging body is pasted in side of said paper packaging box, and when said packaging body is inflated, said paper box is automatically opened.

According to an embodiment of the present invention, wherein further comprising a step that responding a cutting operation or a tearing operation of a cutting device of said allocation unit or said buyers to make a section of an bag packaging continuum form said air bag packaging arrangement.

A working station of air bag packaging, comprising: a storage unit for storing many said air bag packaging arrangements; a controlling unit which comprises a selection module and a processor, wherein said processor is connected with said storing unit and said selection unit to make a worker select corresponding air bag packaging arrangement according to needs; an allocation unit connected with said processor and said storage unit to execute commands of said processor to allocate said corresponding air bag packaging arrangement to said worker; and an inflating unit connected with said allocation unit and said processor to execute commands of said processor to inflate said corresponding air bag packaging arrangement.

According to an embodiment of the present invention, wherein said controlling unit further comprises a scanning module which is connected with said processor to feedback scanning information to said processor for said processor sending commands.

According to an embodiment of the present invention, wherein said controlling unit comprises a voice module, wherein said voice module is connected with said processor to achieve voice interaction to transmit information to said processor.

According to an embodiment of the present invention, wherein said controlling unit comprises a voice module, wherein said voice module is connected with said processor to achieve voice interaction to transmit information to said processor.

According to an embodiment of the present invention, wherein said controlling unit comprises a displaying module, wherein said displaying module is connected with said processor to display corresponding information to said worker for said worker making selection and confirmation conveniently.

According to an embodiment of the present invention, wherein said controlling unit comprises a displaying module, wherein said displaying module is connected with said processor to display corresponding information to said worker for said worker making selection and confirmation conveniently.

According to an embodiment of the present invention, wherein said controlling unit comprises a displaying module, wherein said displaying module is connected with said processor to display corresponding information to said worker for said worker making selection and confirmation conveniently.

According to an embodiment of the present invention, wherein said controlling unit comprises a displaying module, wherein said displaying module is connected with said processor to display corresponding information to said worker for said worker making selection and confirmation conveniently.

According to an embodiment of the present invention, wherein said controlling unit comprises a displaying module, wherein said displaying module is connected with said processor to display corresponding information to said worker for said worker making selection and confirmation conveniently.

According to an embodiment of the present invention, wherein said selection module provides one or more input devices of buttons, input keyboards, touch screens, voice recognition input.

According to an embodiment of the present invention, wherein further comprises a supporting unit operatively connected with said allocation unit, said inflating unit and said processor to execute commands of said processor to open said air bag packaging arrangement to package products.

According to an embodiment of the present invention, wherein further comprises a transferring unit operatively connected with said supporting unit and said processor to execute commands of said processor to transfer said air bag packaging arrangement which has packaged products.

According to an embodiment of the present invention, wherein said supporting unit is adapted for connecting with a shipment machine to package said products transferred out by said shipment machine.

According to an embodiment of the present invention, wherein said inflating unit is connected with said supporting unit and said allocation unit to inflate and open said allocated air bag packaging arrangement to package said products.

A packaging method through a working station of air bag packaging arrangement, comprising: (a′) a processor receiving commands of a worker, and through an allocation unit allocating corresponding air bag packaging arrangement; (b′) inflating said air bag packaging arrangement through an inflating unit; and (c′) packaging corresponding products.

According to an embodiment of the present invention, wherein allocate said air bag packaging arrangement through a supporting unit opening said allocation, and packaging said products, and then inflating said air bag packaging arrangement through said inflating unit.

According to an embodiment of the present invention, wherein allocates said air bag packaging arrangement through a supporting unit opening said allocation, and inflating said air bag packaging arrangement through said inflating unit, and then packaging said products.

According to an embodiment of the present invention, wherein inflating by said inflating unit, and then opening said air bag packaging arrangement which is allocated by said allocation unit opened by a supporting unit to package said products.

According to an embodiment of the present invention, wherein transferring said packaged products to a certain location through a transferring unit.

According to an embodiment of the present invention, wherein said allocation unit, said supporting unit and said transferring unit are connected with a shipment machine, wherein said processor is set a time internal which is corresponding with a shipment speed of said shipment machine to automatically package said products transferred by said shipment machine.

According to an embodiment of the present invention, wherein said supporting is disposed under said shipment machine or on an end portion of said shipment machine.

According to an embodiment of the present invention, wherein said step(a′) further comprises a step that said worker is able to input commands through voice, keyboard or scanning.

According to an embodiment of the present invention, wherein said processor allocates said corresponding air bag packaging arrangement according to corresponding product information which is scanned by a scanning module.

According to an embodiment of the present invention, wherein said processor allocates said corresponding air bag packaging arrangement according to corresponding product information which is scanned by a scanning module.

According to an embodiment of the present invention, wherein said processor matches said corresponding air bag packaging arrangement according to corresponding commands which are inputted by a voice module.

According to an embodiment of the present invention, wherein said processor matches said corresponding air bag packaging arrangement according to corresponding commands which are inputted by a voice module.

According to an embodiment of the present invention, wherein said voice module reminds said worker to make corresponding selection or remind a working state of a working machine.

A monitoring system of offering platform of fluid bag packaging arrangement, comprising: a computing device for storing and analyzing information and data, wherein said computing device comprises a communicating device which is operatively connected with said computing device to allow said computing device to communicate with external information; and at least an offering platform of fluid bag packaging arrangement which comprises a controlling unit comprising an input module, a verifying module, a communicating module, and a processor, wherein said input module, said verifying module and communicating module are respectively and operatively connected with said processor, wherein said input module is used to assistant to select types of said fluid bag packaging arrangement, and said verifying module is used to assistant to complete an authority to said selected fluid bag packaging arrangement, and said communicating module allows said offering platform of fluid bag packaging arrangement to communicate with external information and said computing device.

According to an embodiment of the present invention, wherein said fluid bag packaging arrangement comprises an allocation unit operatively connected with said processor and provides said fluid bag packaging arrangement which is selected and granted authority under a controlling of said processor.

According to an embodiment of the present invention, wherein said verifying module provides one or more devices selected from proximal payment device, remote payment device, receipt recognition device to communicate external information through said communication module.

According to an embodiment of the present invention, wherein said offering platform of fluid bag packaging arrangement further comprises a storage unit to store said fluid bag packaging arrangement therein.

According to an embodiment of the present invention, wherein said offering platform of fluid bag packaging arrangement further comprises a fluid filling device for filling said fluid bag packaging arrangement which is granted authority.

According to an embodiment of the present invention, wherein said fluid filling device is operatively connected with said processor to respond commands of said processor to inflate said fluid bag packaging arrangement which is selected and granted authority.

According to an embodiment of the present invention, wherein said controlling unit further comprises a displaying module which is operatively connected with said processor to display information.

According to an embodiment of the present invention, wherein said controlling unit further comprises an output module which is operatively connected with said processor to output information.

According to an embodiment of the present invention, wherein said controlling unit further comprises a detecting module which is operatively connected with said processor to output information.

According to an embodiment of the present invention, wherein said offering platform of fluid bag packaging arrangement matches said fluid bag packaging arrangement which is suitable for said user's need through said processor recognizing information which is inputted through said input module by said user.

According to an embodiment of the present invention, wherein through said processor recognizing information which is inputted through said input module by said user, said offering platform of fluid bag packaging arrangement receives corresponding data through said communicating module to match said fluid bag packaging arrangement which is suitable for said user's need.

According to an embodiment of the present invention, wherein said offering platform of fluid bag packaging arrangement identifying products through said detecting module detecting information for said processor matching suitable fluid bag packaging arrangement.

According to an embodiment of the present invention, wherein said offering platform of fluid bag packaging arrangement identifying said user through said detecting module detecting information for said processor obtaining corresponding data through said communicating module and then matching fluid bag packaging arrangement meeting to said user's need.

According to an embodiment of the present invention, wherein said fluid bag packaging arrangement has same or different types, and has same or different sizes.

According to an embodiment of the present invention, wherein said allocation unit further comprises a processing device to cut, heat-seal, or extrude a fluid bag packaging continuum at a suitable location formed said fluid bag packaging arrangement to obtain said fluid bag packaging arrangement with suitable size and shape.

According to an embodiment of the present invention, wherein further comprises at least a sensor configured with said fluid bag packaging arrangement, wherein said sensor is selected one or more from temperature sensors, pressure sensors, vibration sensors, gyroscope, position sensors, camera modules, radio modules, light sensors, chemical sensors, humidity sensors, electromagnetic sensors, signal sensing units.

The monitoring method of offering platform of fluid bag packaging arrangement, which comprises following steps: computing device communicating with said offering platform of fluid bag packaging arrangement; and computing device generating feedback information according to communicating results.

According to an embodiment of the present invention, wherein offering platform of fluid bag packaging arrangement receiving said user's operation and recording and transmitting process, environment parameter and results to said computing device.

According to an embodiment of the present invention, further comprising: said computing device generating feedback information according records that received and recorded there before.

According to an embodiment of the present invention, wherein said generated feedback information is selected from one or more of text information, multimedia information, device commands, personnel commands, software parameters, and data parameters.

According to an embodiment of the present invention, wherein said fluid bag packaging arrangement has a same or different size, and further comprises one or more sensors to be started after said fluid bag packaging arrangement being started.

According to an embodiment of the present invention, wherein said sensor further comprises a sensor unit and a communicating unit connected with said sensor unit to allow said sensor to communicate with one or more of external information, said fluid bag packaging arrangement, said computing device.

According to an embodiment of the present invention, wherein said sensor unit provides one or more of a temperature sensing unit, a pressure sensing unit, a vibration sensing unit, gyroscope, a positioning module, a camera module, a radio module, a light sensing unit, a chemical sensing unit, a humidity sensing unit, a electromagnetic sensing unit, a signal sensing unit.

According to an embodiment of the present invention, wherein said allocation unit further comprises a processing device to cut, heat-seal, or extrude a fluid bag packaging continuum at a suitable location formed said fluid bag packaging arrangement to obtain said fluid bag packaging arrangement with suitable size and shape.

The method as recited in claim 88, comprising following steps: a sensor disposed in a fluid bag packaging arrangement starting and transmitting information; and a computing device receiving and recording information transmitted by said sensor, wherein sensor is selected from one or more of a temperature sensing unit, a pressure sensing unit, a vibration sensing unit, gyroscope, a positioning module, a camera module, a radio module, a light sensing unit, a chemical sensing unit, a humidity sensing unit, a electromagnetic sensing unit, a signal sensing unit.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1A and FIG. 2 respectively illustrate the first and second preferred embodiments, and the second preferred embodiment according to the present invention.

FIG. 2 is a block diagram of the above first and second preferred embodiment according to the present invention.

FIG. 3A is a flow diagram of one using manner of the above first and second preferred embodiment according to the present invention.

FIG. 3B is a flow diagram of another using manner of the above first and second preferred embodiment according to the present invention.

FIG. 4 is a working flow diagram of the above first and second preferred embodiment according to the present invention.

FIG. 5 is a working flow diagram of a selected module of the above first and second preferred embodiment according to the present invention.

FIG. 6A- FIG. 6G are flow diagrams respectively illustrating specific using process of the above first and second preferred embodiment according to the present invention.

FIG. 7 is a working flow diagram of a vending device of the above first and second preferred embodiment according to the present invention.

FIG. 8 is a working flow diagram of a controlling device of the above first and second preferred embodiment according to the present invention.

FIG. 9A-FIG. 9K are diagrams of various preferred embodiments of an air bag packaging arrangement according to the present invention.

FIG. 10 is a structural diagram of an inflating valve of an air bag packaging arrangement according to the present invention.

FIG. 11A and FIG. 11B are structural diagrams of constant packaging body formed by the air bag packaging arrangement according to the present invention.

FIG. 12A illustrates an embodying manner of a third preferred embodiment of a working station of the air bag packaging arrangement according to the present invention.

FIG. 12B illustrates an embodying manner of a fourth preferred embodiment of a working station of the air bag packaging arrangement according to the present invention.

FIG. 12C illustrates an embodying manner of a fifth preferred embodiment of a working station of the air bag packaging arrangement according to the present invention.

FIG. 13 is a diagram of a vending device of the above third, fourth, and fifth preferred embodiment according to the present invention.

FIG. 14A is a flowing diagram of one usage manner of the above third, fourth, and fifth preferred embodiment according to the present invention.

FIG. 14B is a flowing diagram of another usage manner of the above third, fourth, and fifth preferred embodiment according to the present invention.

FIG. 15 is a work-flowing diagram of the selected module of the above third, fourth, and fifth preferred embodiment according to the present invention.

FIG. 16A-16D are work-flowing diagrams of displaying modules during the usage process of the above third, fourth, and fifth preferred embodiment according to the present invention.

FIG. 17A and FIG. 17B are work-flowing diagrams of working manners of a working station of the above third, fourth, and fifth preferred embodiment according to the present invention.

FIG. 18 is a work-flowing diagram of controlling module of the above third, fourth, and fifth preferred embodiment according to the present invention.

FIG. 19 is a diagram of a controller of the above first and second preferred embodiment according to the present invention.

FIG. 20A-20K are diagrams of various embodying manners of the air bag packaging arrangement according to the present invention.

FIG. 21 is a structural diagram of inflating vale of the air bag packaging arrangement according to the present invention.

FIG. 22A and FIG. 22B are structural diagrams of constant packaging body formed by the air bag packaging arrangement according to the present invention.

FIG. 23 is a block diagram of a monitoring system of the offering platform of the fluid bag packaging arrangement of a sixth preferred embodiment according to the present invention.

FIG. 24 is a block diagram of a monitoring system of the offering platform of the fluid bag packaging arrangement of a seventh preferred embodiment according to the present invention.

FIG. 25 is a flow diagram of a managing method of the offering platform of the fluid bag packaging arrangement of a sixth preferred embodiment according to the present invention.

FIG. 26 is a flow diagram of a managing method of the offering platform of the fluid bag packaging arrangement of a seventh preferred embodiment according to the present invention.

FIG. 27 is a flow diagram of a managing method of the offering platform of the fluid bag packaging arrangement of a eighth preferred embodiment according to the present invention.

FIG. 28 is a flow diagram of a managing method of the offering platform of the fluid bag packaging arrangement of a ninth preferred embodiment according to the present invention.

FIG. 29 is a block diagram of a managing method of the offering platform of the fluid bag packaging arrangement of a ninth preferred embodiment according to the present invention.

FIG. 30A-30k are diagrams of various preferred embodying manners of the fluid bag packaging arrangement according to the present invention

FIG. 31 is a diagram of an inflating vale of the fluid bag packaging arrangement according to the present invention

FIG. 32A and FIG. 32B are structural diagrams of constant packaging body formed by the air bag packaging arrangement of preferred embodiments according to the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

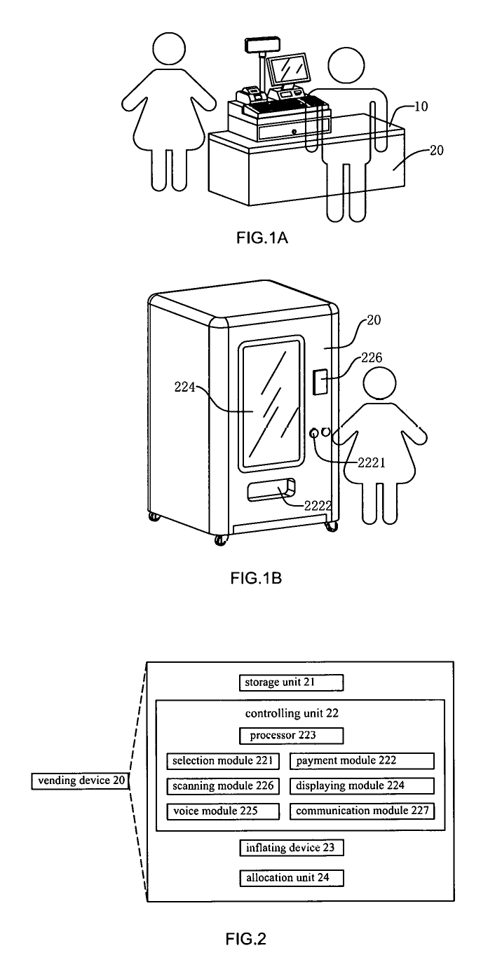

In the retail market such as super market or shopping mall, after shopping, consumers often choose to buy packaging bag or use the packaging bag provided by the merchant to package their products. FIG. 1A and FIG. 1B illustrate different vending device provided by different embodiments according to the present invention, wherein the vending device is used to provide consumers with an air bag packaging arrangement 100. Comparing with the tradition packaging bag, the air bag packaging arrangement 100 have more advantages, and the air bag packaging arrangement 100 shall be further disclosed and illustrated in the following parts of the following specification and the attached drawings.

As shown in FIG. 1A, the vending device is incorporated with a cash register in this certain embodiment, and the cash register is able to be provided to occasions such as super market, shopping mall and other similar occasions, therefore, after consumers finishing the shopping, they are able to directly get the air bag packaging arrangement 100 matched with products that they have bought by the vending device. Except that, the vending device is also able to be solely embodied as a packaging table. As shown in FIG. 1B, the vending device is also able to be embodied as a separate device so as to meet needs that the vending devices are used in different occasions. So, the person skilled in the art shall understand that, the embodying manners of the vending device, which are disclosed in the FIG. 1A and FIG. 1B of the attached drawings of the specification are only examples of the present invention, and can't be treated as limitations to the range and the content of the present invention.

Specifically, as shown in FIG. 1A, the vending device comprises a supporting device 10 and a vending device body 20 which is disposed in the supporting device 10 to be supported by the supporting device 10. For example, in the certain embodiment as shown in FIG. 1A, the vending device body 20 is able to be disposed under or beside the vending device body 20, therefore, the cashier is able to carry out cash collection and packaging on the working surface provided by the supporting device 10, at the same time, while the consumer is waiting for paying the bill, he/she is able to buy and get the air bag packaging arrangement 100 from the vending device body 20 directly to package the purchased products.

It is understandable that, when the vending device is embodied as the packaging table, after the consumer finishing the payment for the purchased produces on the traditional cash register, they are able to use an equipment such as a shopping basket or a shopping cart provided by the super market or the shopping mall to transport the purchased products to the packaging table, and then get the corresponding air bag packaging arrangement through the vending device body 20, and make the packaging operation on the working surface of the supporting device 10 of the packaging table.

Further, as shown in FIG. 2, the vending device body 20 comprises a storage unit 21, a controlling unit 22, a inflating device 23, allocation unit 24 and other possible components, wherein in different embodiments, the storage unit 21, the controlling unit 22 and the inflating device 23 are able to have different configuration relationship, for example, the inflating device 23 is able to be embodied as a single device to separate out of the vending device body 20 so that after purchasing the air bag packaging arrangement 100 from the vending device body 20, the consumer use the inflating device 23 to inflate the air bag packaging arrangement 100. In other words, the consumer or the worker is able to manually use the inflating device 23 such as a pump to inflate the air bag packaging arrangement 100. Except that, in the preferred embodiment of the present invention, the inflating device 23 is also able to be embodied as a pump, which is able to be combined with the storage unit 21, the controlling unit 22, and other components to form the vending device body 20 for the subsequent usage.

Specifically, the storage unit 21 is used to store various air bag packaging arrangements 100 including but not limiting the air bag packaging arrangement 100 which have different model, size. In some embodiments, the variety of the air bag packaging arrangement 100 is also able to be stored in the storage unit 21 for displaying. In other words, the consumer can see the various air bag packaging arrangement 100 stored in the storage unit 21 form the outside of the vending device body 20. The controlling unit 22 is used to assist the consumer to select the air bag packaging arrangement 100 and pay for the selected air bag packaging arrangement 100, and in the subsequent usage process, the controlling unit 22 is able to control the inflating device 23 to complete the operation to inflate the air bag packaging arrangement 100 which are selected and paid for, so that the consumer can get the air bag packaging arrangement 100 which has been inflated finally.

Further specially to speak, the controlling unit 22 comprises a selection module 221 and a payment module 222, wherein the consumer is able to select the type of the air bag packaging arrangement 100 by the selection module 221. Correspondingly, the consumer can also pay for the selected air bag packaging arrangement 100 by the payment module 22, and then inflate the air bag packaging arrangement 100 by the inflating device 23.

Specially, the selection module 221 is able to be embodied to be devices that provide the input mode, such as a selecting button, input keyboard, voice input or touch screen. The payment module 222 is able to be embodied as various payment ways or their combinations, such as paper money or coin delivery and identification devices, credit card devices, etc., to make the consumer complete the payment and purchase conveniently.

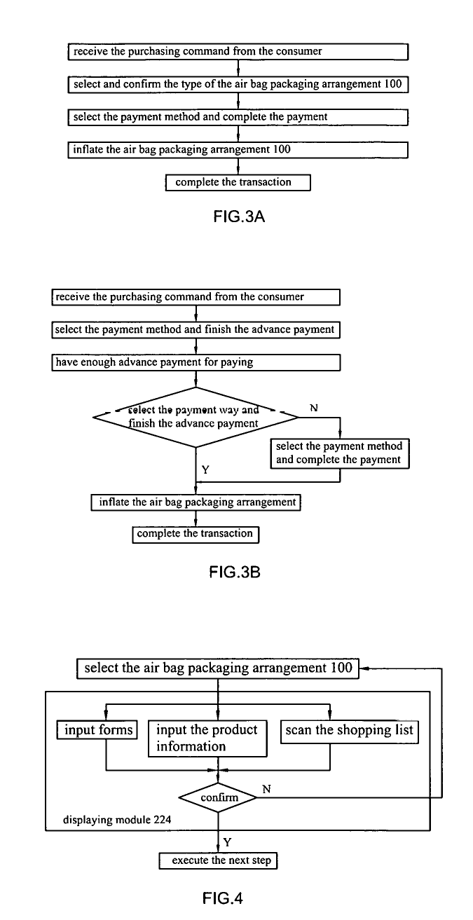

As shown in FIG. 2, the controlling unit 22 comprises a processor 223, wherein the selection module 221 and the payment module are respectively and operatively connected with the processor 223, and the allocation unit 24 and the inflating device 23 are also able to be operatively connected with the processor 223. In other words, when the allocation unit 24 receives commends form the processor 223, the allocation unit 24 is able to execute the allocating operation so as to provide the selected air bag packaging arrangement 200 to the consumer, wherein when the inflating device 23 receives commands from the processor 223, the inflating device 23 is able to operate the inflating operation so as to inflate the selected air bag packaging arrangement 100. The FIG. 3A and FIG. 3B are flow diagrams which respectively illustrate the specific operation mode of the vending device body 20 according to the present invention.

Specifically speaking, as shown in FIG. 3A and FIG. 8, after receiving the purchasing demands form the consumer, the processors 223 shall remind the consumer to select and confirm the type of the air bag packaging arrangement 100 by voice or images, or the consumer or the worker directly put in the related information through the selection module 221, and then the selection module 221 shall generate and feedback a selection identity 101 for illustrating that the air bag packaging arrangement 100 has been selected, and the selection identity 101 shall be received by the processor 223. The processor 223 shall grant authorization the payment module 222 and remind the consumer to choose the payment way and finish the payment by voice or images, etc., and then the payment module 222 shall generate and feedback a payment identity 102 to illustrate that the payment of the selected air bag packaging arrangement 100 has been finished, and the payment identity 102 shall be received by the processor 223. The processor 223 shall grant authority to the inflating device 23 to complete the inflating operation to air bag packaging arrangement 100 which has been selected and paid off, and finally the consumer shall get the air bag packaging arrangement 100 which has been inflated.

It is worth to mention that, the selection identity 101 and the payment identity 102 can be computer code or any other certificates which are able to be received and recognized by the processor 223 so that after respectively receiving the selection identity 101 and the payment identity 102, the processor 223 is able to complete the corresponding action.

It is worth to mention that, the term “processor” that mentioned in the specification and the attached drawings of the present invention is able to be embodied as a processing module that is able to execute commands, or a computer device that is able to execute commands, so that the type of the processor 223 can't be treated as a limitation to the content and range of the present invention.

Accordingly, as shown in FIG. 3B and FIG. 8, after receiving the purchased commands from the consumer, the processor 223 shall grant authority to the payment module 223 to remind the consumers by voice or images too choose the payment way and complete the advance payment, and then the payment module 223 is able to feedback the payment identity 102 to the processor 223. The processor 223 shall grant authority to the selection module 221 to remind the consumer choose and confirm the type of the air bag packaging arrangement 100, and then the selection module 221 feedback the selection identity 101 to the processor 223. Subsequently, the processor 223 shall compare the advance payment with the payable payment of the air bag packaging arrangement 100, and when the advance payment is enough to pay for the selected air bag packaging arrangement 100, the processor 223 shall grant authority to the inflating device 23 to complete the inflating operation of the selected air bag packaging arrangement 100, accordingly, wherein when the advance payment is not enough to pay for the selected air bag packaging arrangement 100, the processor 223 shall notify and grant authority to the payment module 222 to remind the consumer to choose the payment way and pay off the left money again, and the payment module 222 shall feedback the payment identity 102 to the processor 223, and then the processor 223 shall grant authority to the inflating device 23 to complete the inflating operation of the selected air bag packaging arrangement 100. Finally, the consumer shall get the air bag packaging arrangement 100 which has been inflated.

It is worth to mention that, the selection module 221 allows the consumer select the type of the air bag packaging arrangement 100 more than once, and allow the consumer to pay for many selected air bag packaging arrangement 100 together, which provide convenience for the consumer.

It is worth to mention that, if the time that the vending device 200 complete a transaction to take or the time that the transaction is failed after is more than the pre-set time, the vending device 20 shall automatically realize the initialization, and the vending device 20 also allows the consumer to complete the initialization positively for the next usage.

Furthermore, after the air bag packaging arrangement having been selected; the consumer is able to view the specifications of the inflated air bag packaging arrangement 100 including its shape, size, and so on to help the consumer to confirm the selected air bag packaging arrangement 100. Specifically, the controlling unit 22 further comprises a displaying unit 224, wherein the displaying unit 224 is operatively connected with the processor 223 to display the image information such as the selection commands. For example, in some certain embodiments of the present invention, after the processor 223 receiving the selection identity 101, the specification of the selected and inflated air bag packaging arrangement 100 can be viewed by the consumer through the displaying module 224 so as to assist the consumer to confirm the needed air bag packaging arrangement 100. In some other embodiments, the displaying module 223 is also used to preview the state of product which is packaged by the air bag packaging arrangement 100 for the consumer's viewing.

It is worth to mention that, the processor 223 is able to achieve reminding the consumer to choose the type and the supporting way of the air bag packaging arrangement 100 respectively through the displaying module 224, which is easily operated. In one embodiment of the present invention, the displaying module 224, the displaying module 224 is able to be embodied as a display screen or a touch screen, wherein the inflated specification of the selected air bag packaging arrangement 100 is able to be displayed in the displaying module 224 in image through the displaying module 224 so as to be more directly viewed and confirmed by the consumer. In another embodiment of the present invention, the displaying module 224 is also able to receive the input of the commands, that is to say that the displaying module 224 can be a touch controlling display, and is able to complete all functions of the selection module 221, and the command is able to be received and identified by the processor 223 during the subsequent process so as to make the processor 223 execute the corresponding action according to the commands. For example, the consumer is able to put in the information such as name and type, etc., of the products which are ready for being packaged through the displaying module 224, and the input information is able to be sent to the processor 223 in command manner, and at meanwhile, the processor 223 can base the command to automatically match the air bag packaging arrangement 100 which is matched with the products the information of which the consumer has put in.

As shown in FIG. 2, the controlling unit 22 comprises a voice module 225, wherein the voice module 225 is operatively connected with the processor 223 to assist the processor 223 to remind the consumer to do the corresponding operations. In other words, whatever the processor 224 and the voice module 225 are incorporated or separated with each other, they are able to be used to remind the consumer to finish the corresponding operation. For example, the processor 223 is able to grant authority to the selection module 221 and the payment module 222 to respectively invoke at least one of the displaying module 224 and the voice module 225 to remind the consumer to do the corresponding operation.

FIG. 4 is a block diagram of the air bag packaging arrangement 100 of the first and second preferred embodiment according to the present invention, wherein after the processor 223 granting authority to the selection module 221 to remind the consumer to choose the type of the air bag packaging arrangement 100 through at least one of the displaying module 221 and the voice module 225, the consumer is able to choose the type of the air bag packaging arrangement 100 by but not limited by any one of the following methods.

In the first selecting method, the consumer can directly put in the size of the needed air bag packaging arrangement 100 by the displaying module 224, wherein the processor 223 shall receive the commands, and base on the commands to match the air bag packaging arrangement 100 which have a size and shape that accord with the size and shape that have been put in, and the matched air bag packaging arrangement 100 shall display its inflated specifications in image on the display module 224 so as to assist the consumer to make judgment and confirmation of it, wherein after the consumer's confirmation of the air bag packaging arrangement 100, it shall generate and feedback the selection identity 101 to the processor 223. In this method, it can complete all the selection functions by putting the specification information of the needed air bag packaging arrangement in the display module 224.

In the second selecting method, the consumer can directly put in the information of the product that is ready for being packaged through the displaying module 224, wherein the processor 223 shall receive the information, and base on the information to calculate and match the air bag packaging arrangement 100 which has a shape and size that is fit for the products which are ready for being packaged, and the matched air bag packaging arrangement 100 shall display the specifications of the inflated air bag packaging arrangement 100 in image manner on the displaying module 224 to assist the consumer to make judgment and confirmation of it, and after the consumer conforming the selection of the air bag packaging arrangement 100, it shall generate and feedback the selection identity 101 to the processor 223.

In the third selecting method, the consumer can use a scanning module 226 which is operatively connected with the processor 223 to put the shopping list information in the processor 223 by the scanning method. Specifically, the controlling unit 22 comprises the scanning module 226, and the scanning module 226 is operatively connected with the processor 223, wherein the consumer can put the shopping list in the area that the scanning module 226 is able to recognize, such that the shopping list is able to be placed in front of the scanning module 226, wherein, at the same time, through the scanning of the scanning module 226, the information on the shopping list is able be received by the selection module 221 or directly received by the processor 223, wherein the processer shall automatically match the air bag packaging arrangement 100 which is accorded with specifications that recoded on the shopping list, and the matched air bag packaging arrangement 100 shall display the specification of the inflated air bag packaging arrangement 100 in image manner on the displaying module 224 to assist the consumer to make judgment and confirmation, wherein after the consumer having confirmed the selection of the air bag packaging arrangement 100, it shall generate and feedback the selection identity 101 to the processor 223.

In the fourth selecting method, the scanning module 226 operatively connected with the processor 223 is a three-dimensional scanning device which is able to perform a three-dimensional scanning of products that is ready for being packaged to get its size and shape information, and send the information to the processor 223. The processor 223 shall automatically calculate the air bag packaging arrangement 100 which is matched with the produce that is ready for being packaged, wherein after the consumer confirming the selection of the air bag packaging arrangement 100, it shall generate and feedback the selection identity 101 to the processor 223.

However, the people skilled in the art understand that, the vending device body 20 is also able to provide more selection ways for selecting the specification of the air bag packaging arrangement 100.

As shown in FIG. 5, the vending device body 20 provided by the present invention is able to offer various payment ways. Specifically speaking, when the processor 223 grants the payment module 222 authority to remind the consumer to select the payment way through at least one of the displaying module 224 and the voice module 225, wherein the payment way of the vending device body 20 comprises but not limited to the following ways.

In the first payment way, the payment module 222 comprises a slot portion 2221 to receive the coins or the notes the consumer put therethrough, wherein the vending device body 20 further comprises a shipment opening 2222, and the slot portion 2221 is used to receives coins or notes that the consumer put therethrough, and after the processor 223 sending the shipment commend, the allocation device 24 shall transfer the selected air bag packaging arrangement 100 to shipment opening 2222 for the consumer getting the air bag packaging arrangement 100. It is worth to mention that, the shipment opening 222 is also able to be embodied to be an outlet slot at the same time so as to give charges. Specifically, when the consumer needs to pay, she/he can insert coins or notes into the payment module 222 through the slot portion 2221, wherein the payment module 222 shall generate and feedback the payment identity 102 to the processor 223 to complete the payment. It is worth to mention that, in this payment way, the consumer can get the change coins form the shipment opening 2222. The people skilled in the art should understand that, the vending device body 20 is able to provide a single outlet slot which is not made together with the shipment opening 2222.

In the second payment way, the consumer can pay by the payment receipt. Specifically, the consumer can get the payment receipt through advance payment, gifts and other ways, such that the payment receipt can be bought in certain area of occasions that provide the vending device body 20, wherein when need to pay, the payment receipt is able to be scanned by the scanning module 226, and then the information on the payment receipt shall be automatically through the payment module 222 to generate and feedback the payment identity 102 to the processor 223, or the information on the payment receipt shall be received directly by the processor 223, so as to complete the payment.

In the third payment method, the consumer can also through the third-party payment such as Alipay, Wechatting payment, paying code payment, VISA (Visa International Service Association), Master Card or other bank card to complete the payment. For example, when the consumer choose the payment way such as Alipay or Wechatting payment, the processor 223 shall generate the corresponding QR code and display it on the displaying module 224, wherein the consumer can use any devices that pre-install the Alipay or the Wechatting such as mobile phone and the electronic device that is able to connect with the internet through scanning the QR code displayed on the displaying module 224 to achieve the payment. When the consumer choose the paying code payment, the consumer can open the paying code of the paying device such as Alipay, and through scanning the paying code through the scanning module 226, the payment module 222 shall generate the payment identity 102 and send it to the processor 223, or directly feedback it to the processor 223, so as to complete the payment. When the consumer choose the Union Pay, VISA, or the Master Card to pay, the scanning module shall scan magnetic bill that the issuing banks of the Union Pay Card, VISA, or Master Card provide, and coordinate with the telephone number that the consumer has reserved in the issuing banks of the Union Pay Card, VISA, or Master Card to verify the short messages to complete the payment, wherein these short messages shall generate and feedback the payment identity 102 to the processor 223 by the payment module 222, or directly feedback the payment identity 102 to the processor 223, so as to complete the payment. Except that, the payment module 222 is also be embodied to be a card machine, wherein the consumer can directly enter the amount in the card machine, and use a bank card to swipe the card directly on the card machine to carry on expanse.

It is worth to mention that, the controlling unit 22 further comprises a communicating module 227, wherein the communicating module 227 is operatively connected with the processor 223 for the processor 223 being communicatingly connected with the third-party platform, so that when the user choose the third-party payment to pay for the selected air bag packaging arrangement 100, the communicating module 227 is able to coordinate with the service provider of the third-party payment to complete the payment operation. It is worth to mention that, the above disclosed payment methods are only illustrative description and the vending device body 20 is also able to provide other payment methods for consumers' selection. For example, the vending device body 20 is able to be incorporated with other payment methods such as Ka La Ka.

It is worth to mention that, in the first and second preferred embodiment of the present invention, the inflating device 23 is integrally disposed in the vending device body 20, so that when the consumer has purchased the suitable air bag packaging arrangement 100, through the way of pressing corresponding buttons or other switches, the inflating device 23 shall automatically inflate the air bag packaging arrangement 100, and when the inflation is finished, the inflating device 23 shall end the inflation. It is worth to mention that, during the inflation, the consumer can put the produce in the air bag packaging arrangement 100 directly, so that when it is inflating, the air bag packaging arrangement 100 shall package the product therein. Surely, the consumer is also able to put the product in the air bag packaging arrangement after completing the inflation of the air bag packaging arrangement 100.

The inflating nozzle of the inflating device 23 is able to be disposed in a suitable portion of the vending device body 20, such as under the device body, or disposed in the shipment opening 2222, only that it is convenient for inflating the air bag packaging arrangement 100.

In addition, the inflating device 23 is operatively connected with the processor 223, wherein the vending device is able to set up predetermined inflating amount according to various types and specifications of the air bag packaging arrangement 100, so that the processor 223 automatically determines the inflation is completed or not through the inflating time. Certainly, it also can be consumers or workers determining the inflation being completed or not, and then closing the corresponding switch.

The allocation unit 24 can be various suitable structures, such as lifting platform, to transfer the selected air bag packaging arrangement 100 to the shipment opening 2222, or other switches, such as opening a bottom wall of the storage room of the air bag packaging arrangement 100 so that the air bag packaging arrangement 100 shall drop out or slide down by itself, and when the air bag packaging arrangements 100 stored in the corresponding room have been run out, it shall remind workers to or automatically supply the air bag packaging arrangement 100.

It is worth to mention that, the vending device is also able to be configured with various preselected programs according to types of various products and their combinations in the super market. That is to say that, accordingly, there are many matched air bag packaging arrangements 100 with predetermined types and specifications according to these combinations for consumers' selection. Certainly, the different air bag packaging arrangements 100 have different prices, so that when providing the advice information to the consumer, meanwhile, it can inform the consumer the price information.

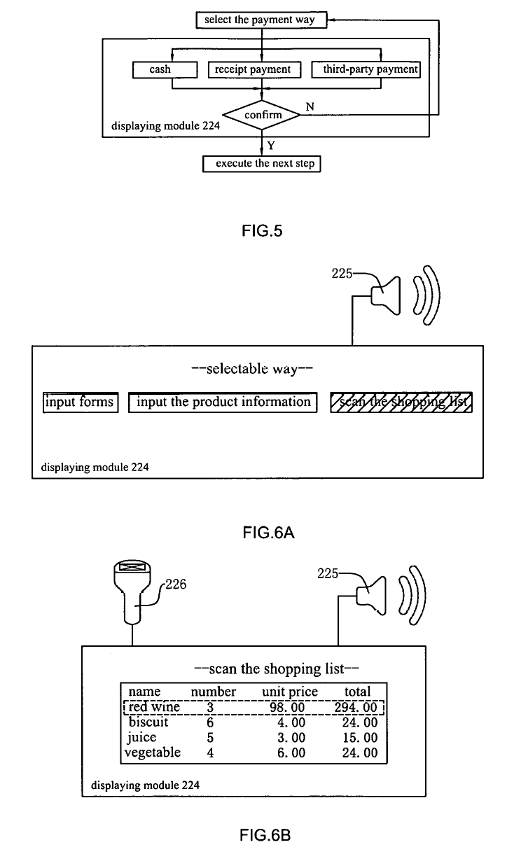

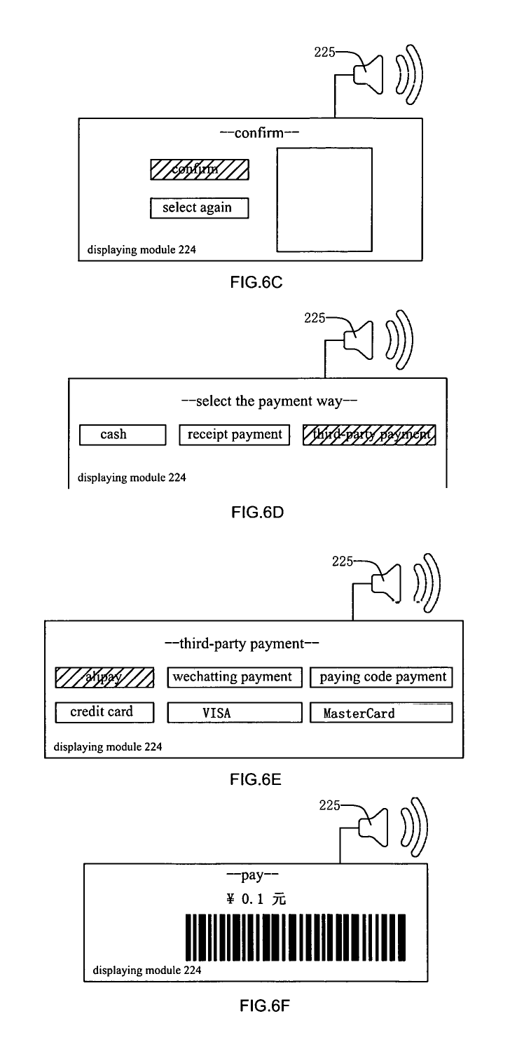

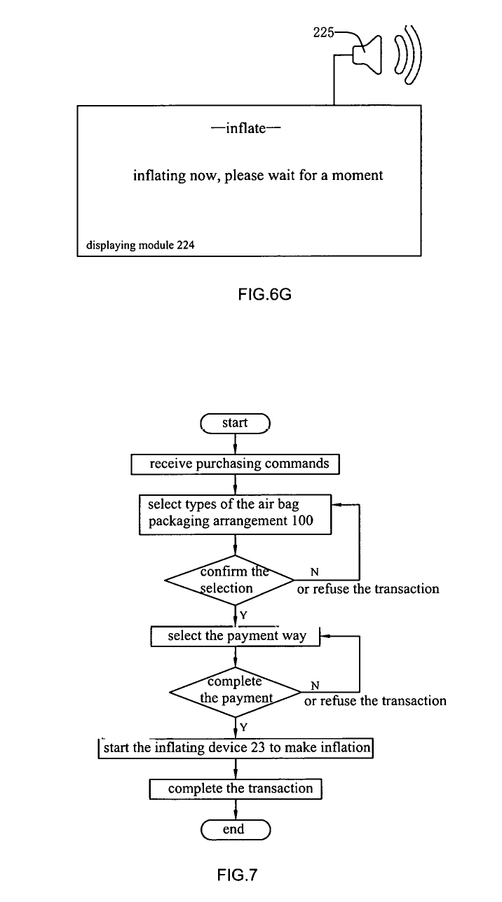

FIG. 6A and FIG. 8 illustrate the using process of the vending device body 20 of a preferred embodiment according to the present invention, wherein after a series of operation, the consumer can purchase the needed air bag packaging arrangement 100 from the vending device body 20.

To be specific, as shown in FIG. 6A, the consumer may buy the red wine and pay for it in the super market or the shopping mall(retail market), and then may purchase the corresponding air bag packaging arrangement 100 from the vending device body 20 to package the red wine. When the consumer's using requirements is generated, the vending device shall response the using requirements of the consumer, and the vending device shall grant authority to the displaying module 224 to display commands in image manner, which provide consumer for selecting the selection methods of the air bag packaging arrangement 100, and is able to selectedly remind the consumer to make the selection in voice at the same time, and at the same time, the processor 223 grants authority to the selection module 221 to receive the or prepare receiving the consumer' selection. The command displayed on the displaying module 224 may include “input the size”, “input product name or type”, “scan the shopping list” and so on, and the consumer can execute the next step by clicking or touching responding areas of these commands. It is worth to mention that, in the following menu of these commands, which is able to comprise other commands which are not illustrated in attached drawings. For example, when the consumer executes the command of “input the size” by clicking or touching, and then the processor 223 shall grant authority to the displaying module 224 to display the command to request the consumer to input parameters such as the length, height of the required air bag packaging arrangement.

In this illustration, the consumer can complete the operation of this step by selecting “scan the shopping list”. After the consumer selecting “scan the shopping list”, the processor 223 shall grant authority to the scanning module 226 to receive the consumer's shopping list information to assist to response the consumer's using demands.

As shown in FIG. 6B, specifically speaking, after the selecting method of the type of the air bag packaging arrangement 100 being confirmed, the vending device body 20 shall allow the consumer to scan the shopping list of the red wine on the scanning module 226, and at the same time, the scanning module shall input the information on the shopping list to the processor 223 for processing, and the displaying module 224 shall totally or partially display the information on the shopping list for the consumer checking.

As shown in FIG. 6C, the processor shall automatically match the air bag packaging arrangement 100 with the red wine according to the input information of the shopping list, and the processor 223 shall grant the displaying 224 to display the inflated state of the selected air bag packaging arrangement 100 to assist the consumer to confirm the type of the air bag packaging arrangement 100, and at the same time, the corresponding area of the displaying module 224 shall display commands such as “confirm the selection” and “select again” in image manner to remind the consumer, and the consumer can confirm the selection by clicking or touching the responding area of these commands, and after the consumer executing the “confirm the selection”, the selection module 221 shall generate the selection identity 101 and feedback it to the processor 223, and after the processor 223 receiving the selection identity 101, it shall grant authority to other modules to work.

As shown in FIG. 6D, the processor shall grant authority to the displaying module 224 to display commands provided for the consumer to select the payment method, and is able to selectively remind the consumer to make selection by the voice module 222 in voice manner at the same time, wherein, at meanwhile, the processor 223 grants the payment module 222 to receive or prepare receiving the consumer's selection. Commands which display in the displaying module 224 may comprises “cash payment”,” paying receipt payment”, “third-party payment” and other payment methods, for the consumer executing the next operation through clicking or touching the responding area of these commands. After the consumer selecting the “third-party payment”, the displaying module 224 shall display the specific information of the third-party payment subsequently such as “Alipay”, “Wechatting payment”, “paying code payment”, “Union Pay”, “VISA”, “Master Card”, and other payment method for the consumer to select, as shown in FIG. 6E.

As shown in FIG. 6F, after the consumer selecting the “Alipay”, the corresponding paying code and the price required to be paid shall be displayed in the displaying module 224, and the consumer can scan the paying code displayed in the displaying module 224 to complete the payment by the Alipay installed in the telephone or other electronic device, and after the consumer completing the payment, the payment module 222 shall generate and feedback the payment identity 102 to the processor 223, and the processor 223 shall subsequently grant authority to the inflating device 23to inflate the air bag packaging arrangement 100 which has been selected and paid, as shown in FIG. 6G, finally, the consumer can get the inflated air bag packaging arrangement 100 for packaging the red wine.

People skilled in art should understand that, the using methods of the above described air bag packaging arrangement 100 are only illustrative description, and shall not limit the content and range of the present invention, and operation commands that display on the displaying module 224 in every step shall be different in different embodiments of the prevention.

Accordingly, as shown in FIG. 10, the present invention provides a selling method of the air bag packaging arrangement 100, and under the controlling of a processor 223 which is able to execute commands, the method comprises the following steps:(a) receiving a purchasing command; (b) the processor 223 responding the purchasing command and matching an air bag packaging arrangement 100 accorded with the purchasing command; and (c) providing the air bag packaging arrangement to the consumer.

The above methods, further comprising a step: executing inflating operation of the air bag packaging arrangement 100.

Preferredly, the step(b) further comprises: (b1)selecting the types of the air bag packaging arrangement 100 through a selection module 221; (b2)completing a payment of the selected air bag packaging arrangement 100 through a payment module 222; (b3) the processor 223 automatically computing and matching a air bag packaging arrangement 100 accorded with the command.

Specifically speaking, after the vending device body 20 receiving the purchasing command of the consumer, the processor 223 shall grant authority to the selection module 221 to assist the consumer to select the type of the air bag packaging arrangement, and after the selection being confirmed, the selection 221 shall generate and feedback a selection identity 101 to the processor 223, wherein the processor 223 shall further grant authority to the payment module 222 to assist the consumer to complete the payment of the selected air bag packaging arrangement, and after the payment being completed, the payment module 222 shall generate and feedback a payment identity 102 to the processor 223, and finally, the processor 223 shall grant authority and control an inflating device 23 to inflate the air bag packaging arrangement 100.

It is worth to mention that, in other embodiments of the present invention, the selling method further comprises the following steps: (b4) completing an advance payment through a payment module 222; (b5) selecting the type of the air bag packaging arrangement 100 through a selection module; (b6) comparing the advance payment with the payable account, wherein when the advance payment is enough to pay for the selected air bag packaging arrangement 100, the payment is completed, if not, it shall continue paying for the remaining account through the payment nodule 222; and (b7)the processor automatically matching the air packaging arrangement according with the purchasing demands.

As shown in FIG. 3B, it illustrates a working-flow diagram of the vending device body 20 under the operation mode.

Preferredly, in the above methods, the selection method of the type of the air bag packaging arrangement is displayed in image manner in a displaying module 224, and the displaying module 224 is able to receive the selected commands and feedback them to the section module 221, and the selection module 221 shall generate and feedback a selection identity 101 to the processor 223.

Preferredly, in the above methods, the selection method of the payment of the air bag packaging arrangement is displayed in image manner in a displaying module 224, and the displaying module 224 is able to receive the payment commands and feedback them to the payment module 222, and the payment module 222 shall generate and feedback a payment identity 102 to the processor 223.

Preferredly, in the above methods, the selection of the type or the payment method of the air bag packaging arrangement 100 is reminded through a voice module 225.

It is worth to mention that, the selecting identity is the identity that the air bag packaging arrangement is selected, and the payment identity is the identity that the payment is completed.

Preferredly, as shown in FIG. 4, wherein in above methods, the processor responds the using demands through at least one of the following methods: inputting the size of the air bag packaging of arrangement in the displaying module; inputting the name and/or type of the purchased product in the displaying module; and scanning the shopping list.

Preferredly, as shown in FIG. 5, in the above described methods, the processor completes the payment through at least one of the following methods: cash payment; paying receipt payment; and the third-party payment.

Preferredly, in the above methods, a scanning module operatively connected with the processor scans the information of the shopping list, and the information of the shopping list is practically or totally displayed on the displaying module.

It is worth to mention that, the present invention also provides an operating method of the vending machine body 20, wherein before operating the vending device body 20, the vending device body 20 shall automatically complete the initialization. It is understandable that, according to need, the vending device body 20 allow the consumer positively initialize it for the convenience of the subsequent operation.

Specifically, as shown in FIG. 11, the vending device body 20 comprises a controlling unit 22, and an inflating device 23, wherein the controlling unit 22 comprises a selection module 221, a payment module 222, and a processor 23, and the selection module 221 and the payment module 222 are respectively operatively connected with the processor 223, and the methods including the following steps: (A)selecting a type of the air bag packaging arrangement 100 in the selection module 221; (B) Completing the payment of the selected air bag packaging arrangement 100 through the payment module 222; and (C) Controlling the inflating device 23 to inflate the air bag packaging arrangement 100.

Certainly, in the step (C), the consumer or other workers are also able to inflate the air bag packaging arrangement 100 manually through the inflating device 23 embodied as a inflating pump.

Preferredly, in the step (A), a displaying module 224 operatively connected with the processor 223 displays the selecting method of the type of the air bag packaging arrangement 100.

Preferredly, in the step (A), a displaying module 224 operatively connected with the processor 223 displays the selecting method of the type of the air bag packaging arrangement 100, and the displaying module 224 is able to receive the selecting commands and feedback them to the processor 221, and the processor 221 shall generate and feedback a selection identity 102 to the processor 223.

Preferredly, in the above step (B), the selectable payment methods are displayed on the displaying module 224, so that the processor 224 receives the command and feedback it to the payment module 222, so that the payment module 222 shall generate and feedback a payment identity to the processor 223.

Preferredly, in the step (A), the type of the air bag packaging arrangement 100 is selected through at least one of the following methods: inputting the size of the air bag packaging arrangement 100 to the displaying module 224; inputting the name and/or the type of the purchased product to the displaying module 224; and scanning the shopping list.

It is worth to mention that, the shopping list is scanned through a scanning module 226 operatively connected with the processor 223.

Preferredly, the payment is completed through at least one of the following payment methods: cash payment; paying receipt payment; and the third-party payment.

It is worth to mention that, the present invention also provides a business method that automatically selling the air bag packaging arrangement, wherein the method comprising the following steps: (1) the seller providing the air bag packaging arrangement; (2) the buyer purchasing the air bag packaging arrangement through the vending device which is placed in the selling place; and (3) the seller drawing the commission from the account that paid by the purchaser who buys the air bag packaging arrangement.

The seller can be various super markets, shopping malls, stores and so on, wherein the buyer purchases products from the sellers, and then the products are packaged by matched air bag packaging arrangement, and then the purchased products are conveniently brought to home or other working station. The sellers also can be logistics companies, wherein according to needs, the buyer selects the suitable air bag packaging arrangement, and the logistics company shall use the air bag packaging arrangement to package the product prepared for transporting. The seller also can be manufactures or distributers. The air bag packaging arrangement 100 can be from the same manufactures or distributers, or be from different manufactures or distributors.

The business can provide the specification information, such as shape and size, of various products that they sell, so that the vending device is able to prepare the air bag packaging arrangements with suitable types and specifications according to these information, and it is able to provide many preselecting programs for the buyer to make a selection.

It is worth to mention that, the buyer can be the consumers, wherein the vending device is able to automatically statics the sale condition so as to improve types of the air bag packaging arrangement 100 and provide consumers with advised preselecting programs according to the consumer's favorites. So that, this business method can benefits the buyer, the business and the seller at the same time.

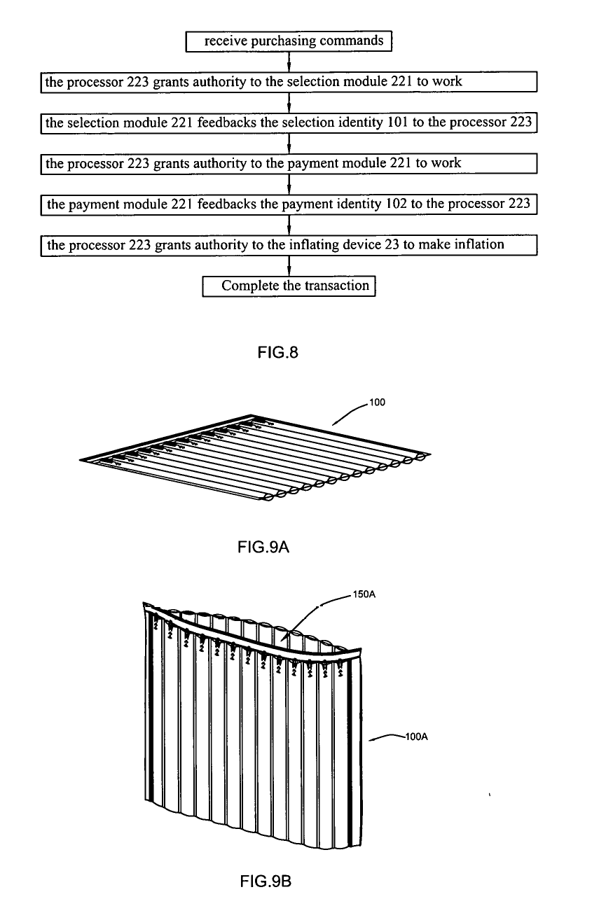

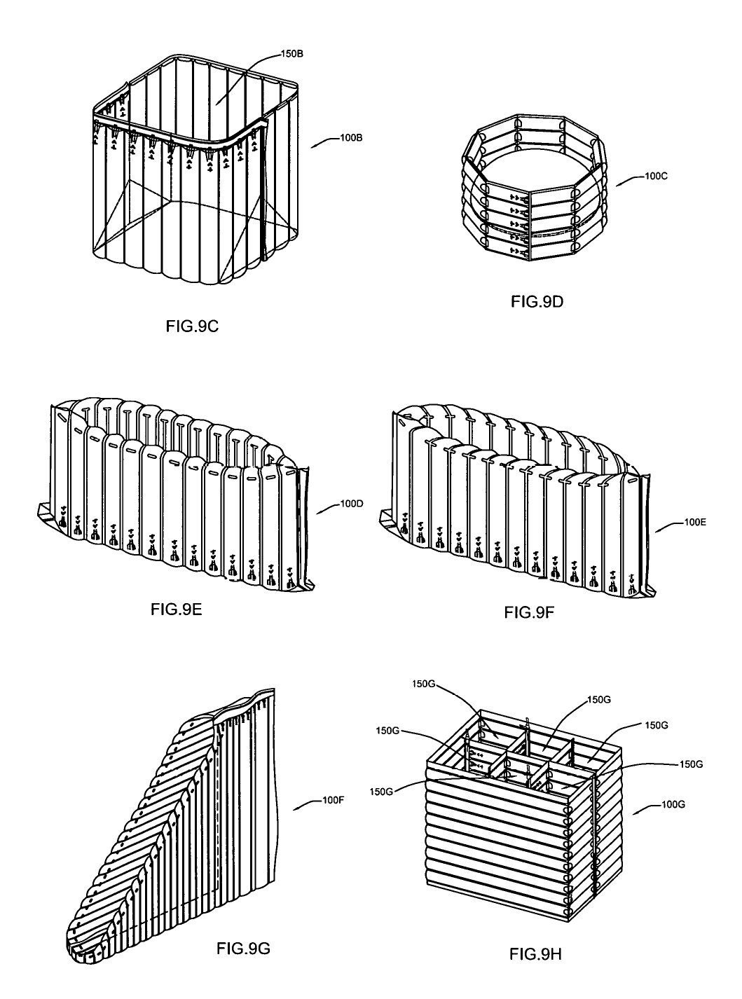

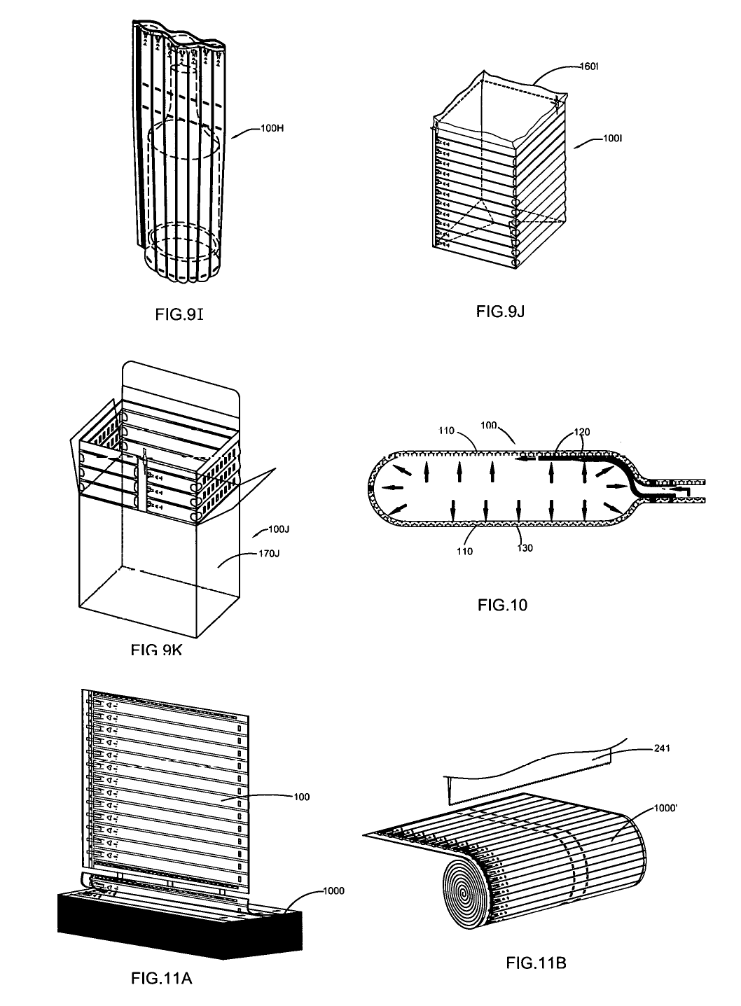

Drawings of FIG. 9A to FIG. 9K illustrate different types of the air bag packaging arrangement 100 according to the present invention. The air bag packaging arrangement 100 mainly provides buffering effect through the inflated air, and in some embodiments, the air bag packaging arrangement 100 further comprises other packaging materials so as to provide extra protecting or buffering effects.

In the first and second preferred embodiments according to the present invention, the air bag packaging arrangement 100 comprises four-layer films which comprise two-layer air chamber films and two-layer valve films that form one-way valves, and through a series of heat sealing to form one or more inflating units 130. During the inflation, the air passes through the two-layer valve films into chambers of each of the inflating units 130, and then after inflating enough air in the inflation chambers of the inflating units, the pressure in the inflation chamber shall be exerted on the two-layer valve films 120 so as to close the air channel between the two-layer valve films 120. The inflating opening of the air bag packaging arrangement 100 is able to be inserted into the inflating mouth of the inflating device 23 so as to inflate the air bag packaging arrangement 100.

As shown in FIG. 9A, the air bag packaging arrangement 100 can be an inflation cushion which forms an inflation material adapted for being filled in the packaging boxes, packaging cases, or packaging bags after being inflated to make a buffering function. As shown in FIG. 9B to FIG. 9K, the air bag packaging arrangement 100 form an accommodating chamber through being bent and heat-sealed itself for accommodating the packaging products. Specifically, as shown in FIG. 9B, the air bag packaging arrangement 100a has many inflation side walls for forming the accommodating chamber 150a, wherein the packaged products are able to be stored in the accommodating chamber 150a, and the total bag body is roughly U-shaped. As shown in FIG. 9C, the air bag packaging arrangement 100b forms the accommodating chamber 150b which has a roughly square shape so as form the square air bag packaging arrangement 100b to accommodate the packaged products which have a roughly square shape such as various electronic devices and so on. As shown in FIG. 9D, the air bag packaging arrangement 100 has a ring shape, which is able to surround around the packaged products as to form the edge-around packaging arrangement. As shown in FIG. 9E, the air bag packaging arrangement 100d is able to form multi-layer inflatable structure, such as the inflatable bag structure formed by overlapping an inner layer with an external layer, to enhance the buffering effect. As shown in FIG. 9F, the inflatable bag structure which is overlapped by the inner layer and the external layer of the air bag packaging arrangement 100e is able to be disposed in misplaced arrangement to reduce its thickness. As shown in FIG. 9g, the inflatable structure of the air bag packaging arrangement 100f is in misplaced and overlapped manner to form a rough triangle so as to form an angle packaged arrangement, such as to be used to package four corners of a TV. As shown in FIG. 9h, the air bag packaging arrangement 100g forms many sub-cavity 150g to store different products. As shown in FIG. 9i, the air bag packaging arrangement 100h forms an extended accommodating chamber 100h, so as to be fit for packaging the extended products such as bottled red wine. As shown in FIG. 9J, an inner portion of the air bag packaging arrangement 100i is incorporated with a fixedly connected inner packaging layer 160i, wherein the packaging layer 160i is able to be other functional material, such as one of waterproof materials, moisture-proof materials, heat-insulated materials, warm-kept materials, shading materials, electrostatic materials, wear-standing materials, printing materials, or the above combinations. Except that, the packaging layer 170jis also able to be packaging box, wherein the air chamber film of the air bag packaging arrangement 100j is pasted with an inner portion of the packaging box, and when it is unused, the packaging box is in the folded state, and when the inflating unit formed by the air chamber film is inflating, the folded packaging box is automatically opened so as to form a bag-in-box structure which has the packaging box outside and the inflating bag inside.

People skilled in art should know that, the above types of the air bag packaging arrangement 100 are not treat as a limitation of the content and range of the present invention, and in practice, it is able to be coordinated with various suitable air bag packaging arrangement 200 according to different needs, and designs the air bag packaging arrangement 100 with different size and shape according to different needs.

It is worth to mention that, each air bag packaging arrangement 100 is able to be individually stored in the storage unit 21, and the storage unit 21 has many individual chamber to respectively store different air bag packaging arrangement 100 with different types or different specifications, wherein when it is used, the allocation unit 24 shall provide the consumer with the selected air bag packaging arrangement 100. As shown in FIG. 11A, ones stored in the storage unit 21 are one or more air bag packaging continuums 1000, wherein the air bag packaging continuum 1000 comprises many air bag packaging arrangements 100, such as the above air bag packaging arrangement 100, 100a, . . . 199j or other air bag packaging arrangements, wherein an easy break connection is able to be formed between the adjacent air bag packaging arrangement 100 so that when the allocation unit 24 transfers the air bag packaging arrangement 100 to the shipment opening 2222, the buyer can tear off the air bag packaging arrangement 100 easily for packaging products which are ready for being packaged. It is worth to mention that, such as in this embodiment, the storage unit 21 is able to store many rolls of the air bag packaging continuums 100, and the types and specifications of the air bag packaging arrangement 100 corresponding to each of the air bag packaging continuums 1000 may be the same of different.

As shown in FIG. 11B, each of the air packaging continuums 1000′ may be not apparently divided into a plurality of air bag packaging arrangements 100 like FIG. 11A, but is able to be divided according to needs. In other others, when the buyer has selected the suitable size, the allocation 24 shall further comprises a cutting device such that the air bag packaging continuums 1000 is rolled on the reel for storing and the processor 223 correspondingly computes the cutting location that is required, such as through the rolling speed of the reel, the radius of the rolled air bag packaging continuums 1000′ and the thickness of a layer of the air bag packaging continuums 1000′ to determine the cutting location, so as to cut a suitable section of the air bag packaging continuums 1000′ which has a suitable size to provide it to the consumer. Herein, the section of the air bag packaging continuum 1000′ is treated as an air bag packaging arrangement 100 to provide to the consumer. The section of the air bag packaging continuum 1000 is able to be coordinated with other packaging materials such as packaging box, packaging case and so on to provide buffering effect.

In the logistics service companies, factories, large shopping malls, and large online shopping supermarket, etc., for that the daily shipment are very large and products are required to be packaged before being transported, the present invention provides a station of the air bag packaging arrangement 100 which is able to provide air bag packaging arrangement 100 for packaging the products, and is able to automatically to complete the inflation so as to make the packaging work easier and more efficient.

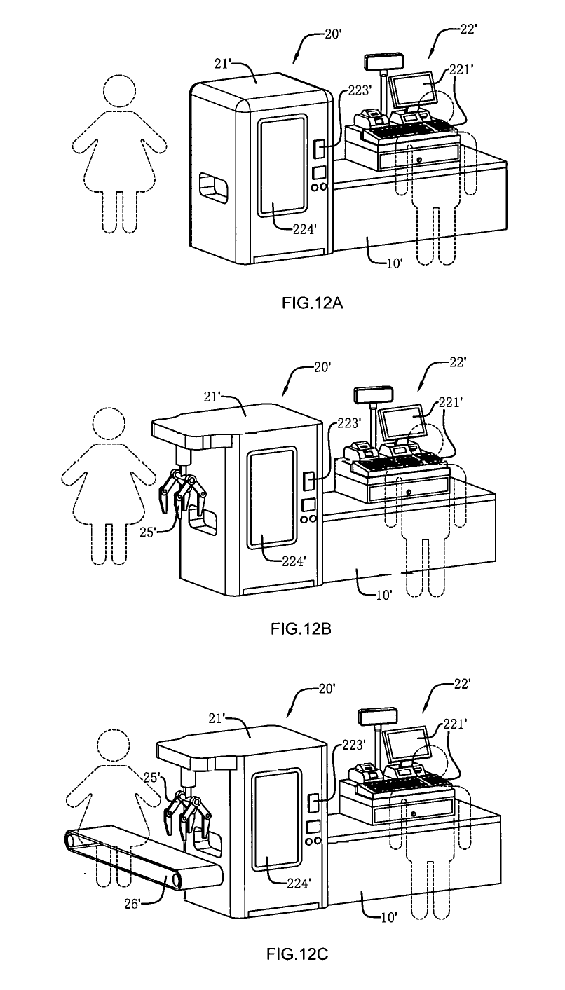

FIG. 12A to 12C illustrate a working station of the air bag packaging arrangement according to the present invention, wherein the working station is adapted for being disposed in the factory, the logistics company, or the large online shopping supermarket etc., which has large daily shipments for using, wherein the working station comprises a supporting bracket 10′ and an automatic working machine 20′, wherein the supporting bracket 10′ is matched with the automatic working machine 20′ a so as to support the automatic working machine 20′, wherein the supporting bracket 10 is able to be disposed on any portion of the automatic working machine 20′.

The automatic working machine 20′ comprises a storage unit 21′ a controlling unit 22′, an allocation unit 23′, and a inflating unit 24′ and other possible componets, wherein the storage unit 21′ is used to store many air bag packaging arrangements 100′, wherein the air bag packaging arrangement 100′ which is stored in the storage unit 21′ may have same type, same specifications including size, shape, or not, and is able to be selected according to practical needs to package the different products.

In different embodiments, the storage unit 20′, the controlling unit 22′ and the inflating unit 24′ are able to have different configured relationship. For example, the inflating unit 24′ is able to be embodied an individual device which is separate from the automatic working machine 20′, wherein when the worker get the air bag packaging arrangement 100′ from the storage unit 21′, and make the inflating operation through the externally disposed inflating unit 24′, that is to say that, the worker can manually use the inflating unit 24′ such as air pump to inflate the air bag packaging arrangement 100′. Except that, the inflating unit 24′ is disposed in the automatic working machine 20′, wherein when the storage unit 21′ transfers out the air bag packaging arrangement 100, it shall automatically make the inflation through the inflating unit 24′, and then packages products, or after packaging products, and then automatically make the inflation through the inflating unit 24′.

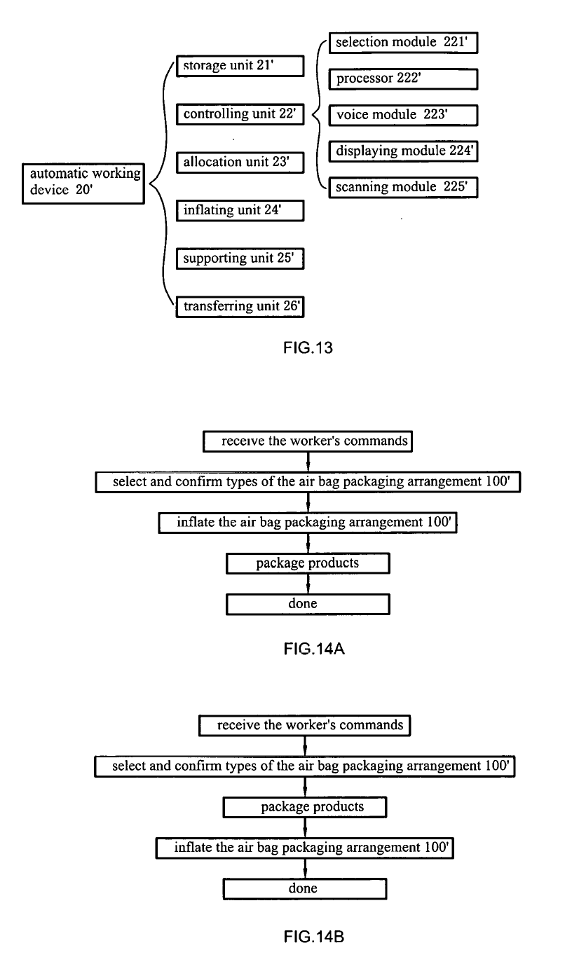

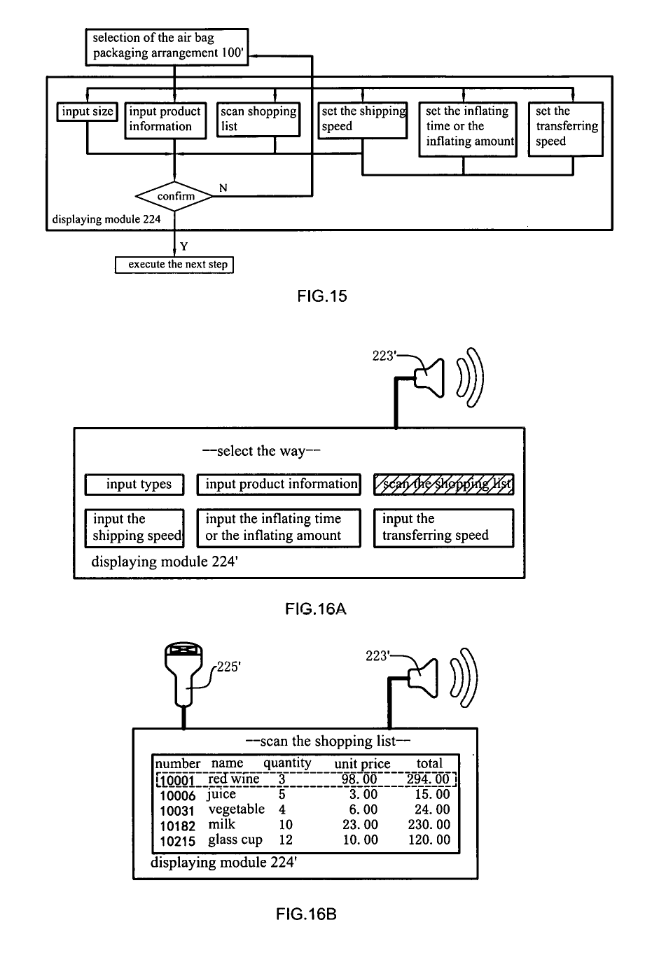

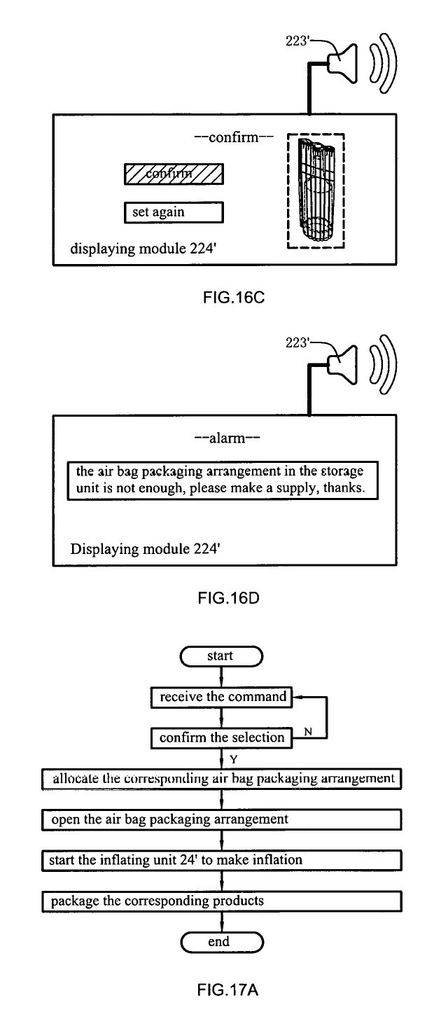

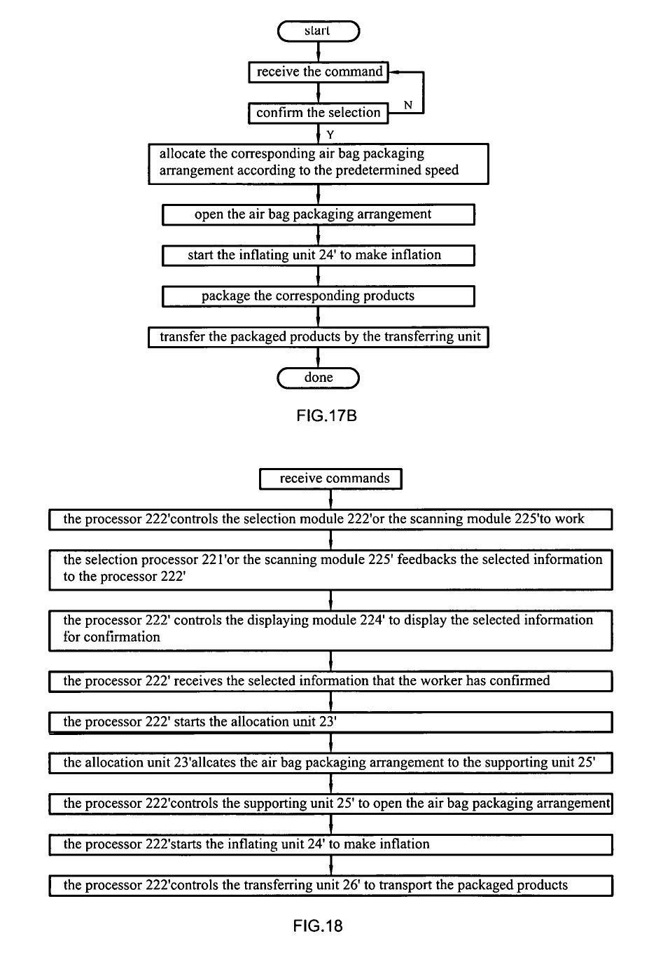

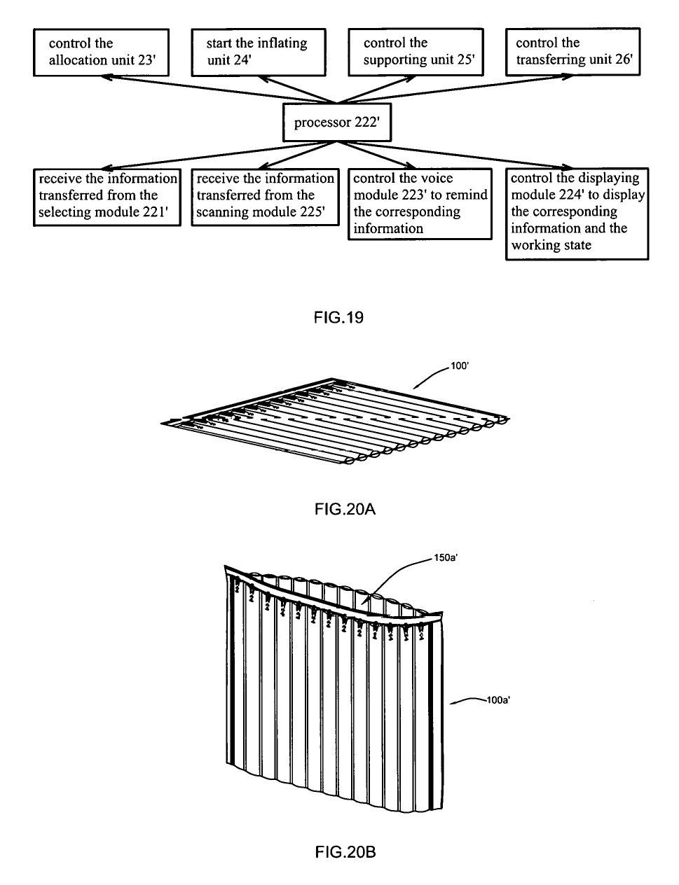

As shown in FIG. 13-FIG. 19, the controlling unit 22′ comprises a selection module 221′, wherein the worker is able to select the air bag packaging arrangement 100′ through the selection module 221′ to match with the corresponding products. Specifically, the selection module 221′ is able to embodied to be buttons, input keyboard, voice input, touching screen and other devices that provides input methods.

The controlling unit 22′ comprises a processor 222′, wherein the selection module 221′ is operatively connected with the processor 222′, and the inflating unit 24′ and the allocation unit 23′ are respectively connected with the processor 222′. In other words, when the worker sends the required commands of the selected air bag packaging arrangement 100′ to the processor 222′ through the selection module 221′, the processor 222′ sends the controlling commands to the allocation unit 23′, and when the allocation unit 23′ receives the controlling commands from the of the processor 222′, the allocation unit 23′ shall execute the allocation operation so as to provide the selected air bag packaging arrangement 100′ to the worker, wherein when the inflating unit 24′receives the controlling commands of the processor 222′, the inflating unit 24′ shall execute the inflating operation so as to inflate the elected air bag packaging arrangement 100′.

Specifically, after the processor 222′ having received the request from the worker, it shall remind the worker in voice or image manner, etc., to select and confirm the type of the air bag packaging arrangement 100′, or after the worker inputting related selection information through the selection module 221′, the selection module 221′ shall generate and feedback an identity which is used to prove that the air bag packaging arrangement 100′ has been selected, and the identity shall be received by the processor 222′.

It is worth to mention that, the worker can input types of the air bag packaging arrangement 100 and the amount of each type of the air bag packaging arrangement 100 one by one through the selection module 221′, and set up the shipment order and the shipment interval of each type of the air bag packaging arrangement 100′, and the selection of the types of a plurality of air bag packaging arrangement 100 can be accomplished by one setting, which shall save time, and because of the setting of the corresponding order and interval, the worker shall have enough time to accomplish the packaging of products. For example, for the larger online super market, orders that a user has made may contain a plurality of products, and the user can select a plurality of corresponding air bag packaging arrangements 100 through one setting to accomplish the packaging of products one by one.

It is worth to mention that, the term “processor” that mentioned in the specification and the attached drawings of the present invention is able to be embodied as a processing module that is able to execute commands, or a computer device that is able to execute commands, so that the type of the processor 223 can't be treated as a limitation to the content and range of the present invention.

The controlling unit 22′ further comprises a voice module 223′, wherein the voice module 223′ operatively connected with the processor 222′ to assist the processor 222′ to remind the worker to make corresponding operation, also through the voice that the voice module 223′ makes to prompt the types of the air bag packaging arrangement 100′ which is in shipment and is ready for shipment so as to remind the worker to package the corresponding products or make a confirmation, and when mistakes occur, they can be adjusted in time.

After the air bag packaging arrangement 100 having been selected, the worker is able to check the specifications including the shape, size, etc. of the inflated air bag packaging arrangement 100 through a displaying module 224′, which is convenient for the worker to confirm the selected air bag packaging arrangement 100′. Specifically speaking, the controlling unit 22′ comprises the displaying 224′, wherein the displaying module 224′ is operatively connected with the processor 222′ to provide image information such as the selection command for displaying. For example, in some embodiments of the present invention, after the processor 222′ receiving the selection identity, the specifications of the inflated selected air bag packaging arrangement 100′ are able to be checked by the worker through the displaying module 224′ so as to assist the worker to make a confirmation of the air bag packaging arrangement 100′. In other embodiments, the displaying module 224′ is also able to be used to preview the packaged state of the products prepared for being packaged by the air bag packaging arrangement for the worker to check and confirm to avoid configured mistakes.

It is worth to mention that, the displaying module 224′ and the processor 222′ are able to remind the consumer to make the selection of the types and the supporting mode respectively so as to be convenient for the operation. In one certain embodiment according to the present invention, the displaying module 224′ is embodied to be a display screen or a touch screen, wherein the specification of the selected inflated air bag packaging arrangement 100′ is able to be displayed in the displaying module 224′ in image manner through the displaying module 224′ for the consumer more directly viewing and confirming. In another embodiment of the present invention, the displaying module 224′ is also able to receive the input of the commands which are bale to be received and recognized by the processor 222′ in subsequent process so as to make the processor 222′ execute corresponding actions according to the these commands. For example, the worker is able to input the information such as name, brand of the products that are ready for being packaged through the displaying module 224′, and the input information is able to be sent to the processor 222′ in command manner, and at the same time, the processor 222′ is able to base these commands to automatically match the air bag packaging arrangement 222′ with products the information of which the worker has input. For example, for factories and large shopping market, according to the situation of the daily shipment, types of products are bale to be predeterminedly input to the processor 222′, and when these products are required to packaged, it only need to select the corresponding products or codes of the products on the displaying module 224′ to select corresponding air bag packaging arrangement 100, which is selected conveniently.

It is worth to mention that, the displaying module 224′ and the voice module 223′, whether individually or in combination, are able to remind the worker to finish the corresponding operation. For example, the processor 222′ is able to accept the selection module 221′ to invoke at least one of the displaying module 224′ and the voice module 223′ to remind the worker to make corresponding operation.

Except that, the voice module 223′ is able to indicate the worker whether the storage unit is out of stock and whether the shipment is normal or not. For example, after the worker inputting the required amount of the air bag packaging arrangement 100′, if the air bag packaging arrangement 11 stored in the storage unit 21′ are not enough to meet the need, the voice nodule 223′ shall sound a corresponding voice to remind the consumer to supply the air bag packaging arrangement 100′ or change the selection. When the automatic working machine 20′ is broken down and not able to ship products and package products normally, the voice module 223′ shall also sound an alarming voice to alarm the worker that the automatic working machine 20′ has been broken down for handling it in time so as to prevent from serious condition, which is so important for the automatically packaging.

It is worth to mention that, in one preferred embodiment of the present invention, the inflating unit 24′ is integrally connected with the automatic working machine 20′. When the working station is applied in the factory, it is adapted for being disposed beside the shipment machine, and connected with the shipment machine for easy line operation to achieve the automatic packaging. That is to say that, when these products are shipped out of the shipment device, they are immediately packaged through the automatic working machine 20′ by the air bag packaging arrangement 100′, and then the air bag packaging arrangement 100′ is inflated through the inflating unit 24′, wherein both that the packaging is first and the inflation is second, and the inflation is first and the packaging is second are ok, wherein it is required to dispose a supporting unit 25′ in the automatic working machine 20′, wherein the supporting unit 25′ is connected with the processor 222′, the storage unit 21′, the allocation unit 23′ and the inflating unit 24′, wherein when the air bag packaging arrangement 100′is shipped out from the storage unit 21′, the allocation unit 23′ shall transfer the corresponding air bag packaging arrangement 100′ to the supporting unit 25′, and at the same time the supporting unit 25′ receives there commands of the processors 222′ so as to open the air bag packaging arrangement 100′, and the product shall automatically enter into the air bag packaging arrangement 100′and be packaged automatically. Except that, the inflating unit 24′ is also able to receive commands of the processor 222′, and at the same time, the inflating unit 24′ is able to inflate the air bag packaging arrangement 100′ during the process of the supporting unit 25′ opening the air bag packaging arrangement 100′, after opening the air bag packaging arrangement 100′, or before opening the air bag packaging arrangement 100′. Furtherly, if the supporting unit 25′ is connected with the shipment opening of the shipment machine, it shall achieve the automatic packaging. Certainly, the worker also manually puts the product in air bag packaging arrangement 100′ which is opened by the supporting unit 25′ to achieve the semi-automatic packaging so as to save the time that the worker opens the air bag packaging arrangement 100′ and the inflating time to increase the packaging efficiency.

It is worth to mention that, the processor 222′ is set a corresponding interval time to provide the air bag packaging arrangement 100′ according to the shipment speed, and reserves a corresponding packaging time to constantly and automatically package the products.

Except that, the inflating unit 24′ and the processor 222′ are operatively connected with each other, wherein the working station of the air bag packaging arrangement 100′ has a predeterminedly inflating amount, so that the processor 222′ is able to determine whether the inflation is completed by controlling the inflating time and inflating time so as to ensure that the proper amount of inflation can be charged.

The allocation unit 24′ can be various suitable structures, such as lifting platform, to transfer the selected air bag packaging arrangement 100′ to the shipment opening 2222, or other switches, such as opening a bottom wall of the storage room of the air bag packaging arrangement 100′ so that the air bag packaging arrangement 100′ shall drop out or slide down by itself and then into the supporting unit 25′ for further usage.

The supporting unit 25 can be various suitable structures, which includes the structure that is able to open and support the air bag packaging arrangement 100, wherein they are bale to change the air bag packaging arrangement 100 according to these commands of the processor 222′. That is to say that, it shall transfer the air bag packaging arrangement 100′ to the predetermined place and then open the next air bag packaging arrangement 100.

For example, for the large online shopping super market, the worker need to deposit the air bag packaging arrangement 100′ in the storage unit 21′ in advance, and input corresponding information of products and types of the air bag packaging arrangements 100 which are matched with these products to the processor 222, wherein when after the worker inputting numbers of the information of the corresponding product, the processor 225′ shall automatically match the suitable air bag packaging arrangement 100, or after scanning the shopping list through the scanning module 225′, it shall automatically match the corresponding air bag packaging arrangement 100′ and automatically inflate it, and prompt products that matched with the air bag packaging arrangement 100′ in voice so as to remind the worker accurately to package the product. For the large online supper market or the logistics companies, they commonly have corresponding shipment lists when those products are shipped out, and the scanning module 225′ is also able to prepare the air bag packaging arrangement 100 through scanning these shopping lists, which shall save time and effectively increase the packaging efficiency.

The automatic working machine 20′ further comprises a transferring unit 26′, wherein the transferring unit 26′ is connected with the processor 222′, the allocation unit 23′ and the supporting unit 25′, wherein after the air bag packaging arrangement 100′ automatically packaging the corresponding products, under the controlling of the processor 222′, the air bag packaging arrangement 100′ automatically withdraws from the supporting unit 25′ and enter into the transferring unit 26′ so as to be transferred to a predetermined location for the worker executing the next operation. It is worth to mention that, the processor 222′ controls the air bag packaging arrangement 100′ to reserved time of the supporting unit 25′ to leave enough time to open, package and inflate the air bag packaging arrangement 100′, wherein the processor 222′ is able to set up a corresponding reserved time according to the speed of the shipment, opening, packaging, and inflating speed of the air bag packaging arrangement 100 to ensure to reserve enough time to let products get timely and perfect packaging.

For example, when the working station of the air bag packaging arrangement is applied in factories, it needs to connect the supporting unit 25′ with the shipment opening of the automatic shipment machine so as to transfer the product to the air bag packaging arrangement 100 which is opened in the supporting unit 25′, wherein after the air bag packaging arrangement 100′ receiving the product and completing the packaging of it, under the controlling of the processor 222′, it shall transfer to the transferring unit 26′ and further transfers it to the corresponding location. It is worth to mention that, the supporting unit 25′ is able to be disposed under the shipment opening of the shipment machine or at the top of the shipment opening of the shipment machine.

The processor 222′ controls the allocation unit 23′ and the transferring unit 26′ according to the shipment speed of the shipment machine and packaging time and inflating time of the air bag packaging arrangement 100′ so as to accord to the predetermined speed to change the air bag packaging arrangement 100′ in the supporting unit 25′, and controls the transferring speed of the transferring unit 26′ to timely transfer the packaged products which shall prevent the pile of the packaged products.

The working process of the air bag packaging arrangement comprises the following steps:

(a′) the processor 222′ receiving commands of the worker, and allocating corresponding air bag packaging arrangement 100′ to the worker;

(b′) the inflating unit 24′ adapted for inflating the air bag packaging arrangement 100′; and

(c′) the air bag packaging arrangement 100 used to package the corresponding products.

In the step (a′), which comprising the following steps:

(a′1) through the selection module 221′ or/and the voice module 223′ inputting these commands, wherein these commands comprise the type and the specification of the air bag packaging arrangement 100, the corresponding product code, the setting of inflating time, the shipment speed of the air bag packaging arrangement 100′, the changing speed of the supporting unit 25′, the transferring speed of the transferring unit 26′, and other commands required to set;

(a′2) the processor 222′ automatically computing, or through the scanning of the scanning module 224 and the allocation unit 23′ allocating the corresponding air bag packaging arrangement 100′ to workers.

The above step (b′) further comprises the following steps:

(b′1) the supporting unit 25′ receiving the air bag packaging arrangement 100′ which is matched by the allocation unit 23′;

(b′2) the inflating unit 24′ inflating the air bag packaging arrangement 100′ supported by the supporting unit 25′ to make the air bag packaging arrangement 100′ have buffering function.

It is worth to mention that, the step (b′2) is ahead of the step (b′1). In other words, inflate the air bag packaging arrangement 100′ first, and then open the air bag packaging arrangement 100′ through the supporting unit 25′, and further package products.

The above step (c′) comprises the following steps:

(c′1) automatically packaging products through the automatic working machine, which is adapted for the factory, such as brewery, red wine factory, milk factory, drink factory, and so on, and connecting the supporting unit 25′with the shipment opening of the shipment machine of the factory products, wherein the processor 222′ setting the speed that the supporting unit changes the air bag packaging arrangement 100′ according to the shipment speed and the inflating time of the air bag packaging arrangement 100′, and transferring the packaged products through the transferring unit 26′ to the predetermined location so as to achieve the automatic packaging; and

(c′2) through the automatic working machine 20′ to package the product manually, which is adapted for logistics companies, storage bases of the large online shopping supermarkets, factories etc., wherein after the air bag packaging arrangement 100′ being opened by the supporting unit 25′, the worker puts the product in the accommodating cavity of the air bag packaging arrangement 100′, and then inflate it, or after the inflation and then the worker puts the product in the air bag packaging arrangement 100′ for packaging, and the packaged product is able to be transferred to the predetermined location by the transferring unit 26′, or the worker directly put the packaged product in the predetermined location. It is worth to mention that, the worker sets the speed of the supporting unit 25′ changing the air bag packaging arrangement 100′ according to the normal packaging speed, to make the worker package the product constantly, which shall save the time that the worker looks for, opens, or inflates the air bag packaging arrangement 100, so as to enhance the packaging efficiency and save the labor intensity of the worker.

After the allocation unit 23′ allocating the corresponding air bag packaging arrangement 100′, the worker gets the air bag packaging arrangement 100 manually, and further packages the corresponding products, and after the packaging being completed, the air bag packaging arrangement 100 is placed in the inflating unit 24′ to inflate automatically.

After the allocation unit 23′ allocating the corresponding air bag packaging arrangement 100′, the air bag packaging arrangement 100′ enters into the supporting unit 25′, and is opened up by the supporting unit 25′, and is inflated by the inflating unit 24′, and then the worker shall put the corresponding products in the air bag packaging arrangement 100′ and control the supporting unit 25′ to change the air bag packaging arrangement 100′ through pressing a button to start the processor 222′, to make the air bag packaging arrangement 100 which has packaged the product enter into the transferring unit 26′, and the allocation unit 23′ allocates one air bag packaging arrangement 100′ to the supporting unit 25′ for further opening and inflating, and then package the product to transport, by analogy.

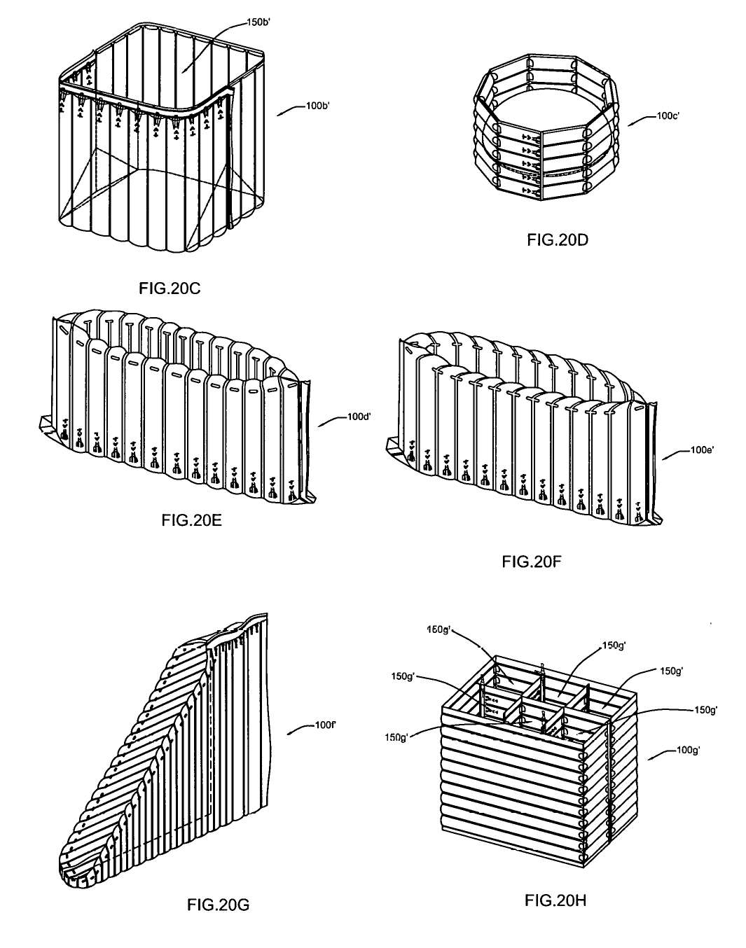

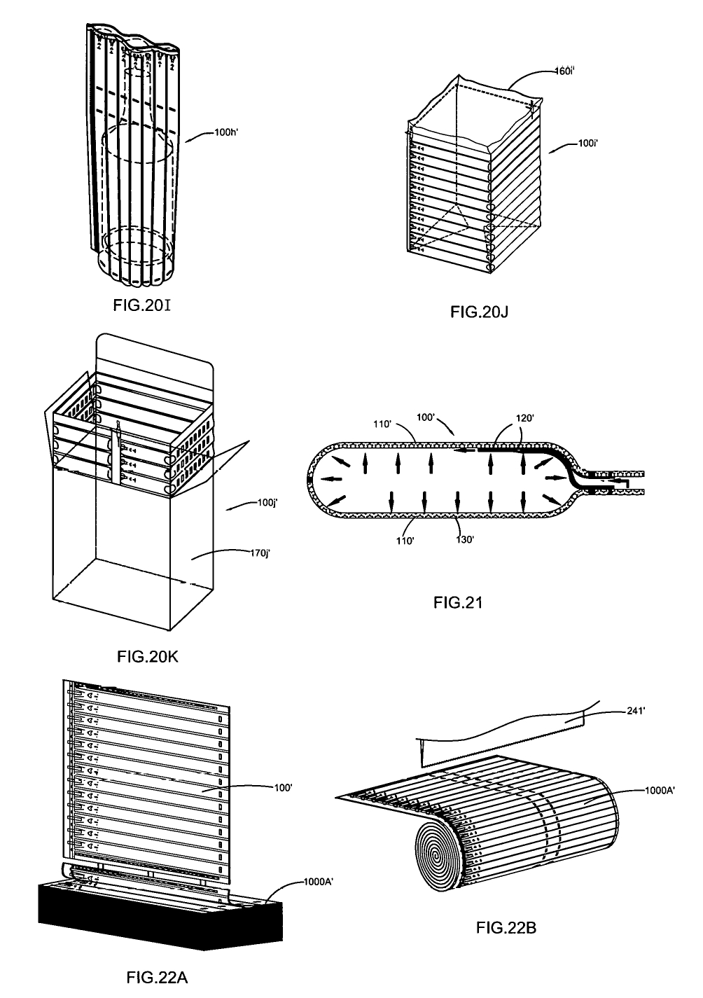

As shown in FIG. 20A to FIG. 20K, they illustrate various types of the air bag packaging arrangement 100′ of the present invention. The air bag packaging arrangement 100′ provided buffering effect mainly through charging air, and in some embodiments, the air bag packaging arrangement 100′ further comprises other packaging materials so as to provide extra protection or buffering effect.

In the third, fourth, and fifth preferred embodiments of the present invention, the air bag packaging arrangement 100′ comprises four-layer films which comprise two-layer air chamber films 110′ and two-layer valve films 120′ that form one-way valves, and through a series of heat sealing to form one or more inflating units 130′. During the process of the inflation, the air passes through the two-layer valve films into chambers of each of the inflating units 130′, and then after inflating enough air in the inflation chambers of the inflating units, the pressure in the inflation chamber shall exert on the two-layer valve films 120′ so as to close the air channel between the two-layer valve films 120′. The inflating opening of the air bag packaging arrangement 100′ is able to be inserted into the inflating mouth of the inflating unit 24′ so as to inflate the air bag packaging arrangement 100′.

As shown in FIG. 20A, the air bag packaging arrangement 100′ can be an inflation cushion which forms an inflation material adapted for being filled in the packaging boxes, packaging cases, or packaging bags after being inflated to make a buffering function. As shown in FIG. 20B to FIG. 20K, the air bag packaging arrangement 100′ form an accommodating chamber through being bent and heat-sealed itself for accommodating the packaging products. Specifically, as shown in FIG. 20B, the air bag packaging arrangement 100a′ has many inflation side walls to form the accommodating chamber 150a′, wherein the packaged products are able to be stored in the accommodating chamber 150a′, and the total bag body is roughly U-shaped. As shown in FIG. 20C, the air bag packaging arrangement 100b′ forms the accommodating chamber 150b′ which has a roughly square shape so as form the square air bag packaging arrangement 100b′ to accommodate the packaged products such as various electronic devices, which have a roughly square shape. As shown in FIG. 20D, the air bag packaging arrangement 100 has a ring shape, which is able to surround around the packaged products as to form the edge-around packaging arrangement. As shown in FIG. 9E, the air bag packaging arrangement 100d′ is able to form multi-layer inflatable structure, such as the inflatable bag structure formed by overlapping an inner layer with an external layer, to enhance the buffering effect. As shown in FIG. 20F, the inflatable bag structure of the air bag packaging arrangement 100e′, which is overlapped by the inner layer and the external layer, is able to be disposed in misplaced arrangement to reduce its thickness. As shown in FIG. 20G, the inflatable structure of the air bag packaging arrangement 100f is arranged in misplaced and overlapped manner to form a rough triangle so as to form an angle packaged arrangement, such as to be used to package four corners of a TV. As shown in FIG. 20H, the air bag packaging arrangement 100g′ forms many sub-cavity 150g′ to store different products. As shown in FIG. 20I, the air bag packaging arrangement 100h′ forms an extended accommodating chamber 100h′ which is fit for packaging the extended products such as bottled red wine. As shown in FIG. 20J, an inner portion of the air bag packaging arrangement 100i′ is matched with a fixedly-connected inner packaging layer 160i′, wherein the packaging layer 160i′ can be other functional materials, such as one of waterproof materials, moisture-proof materials, heat-insulated materials, warm-kept materials, shading materials, electrostatic materials, wear-standing materials, printing materials, or combinations of the above. Except that, the packaging layer 170j′ is also able to be packaging box, wherein the air chamber film of the air bag packaging arrangement 100j′ is pasted with an inner portion of the packaging box, and when it is unused, the packaging box is in the folded state, and when the inflating unit formed by the air chamber film is inflating, the folded packaging box is automatically opened so as to form a bag-in-box structure which has the packaging box outside and the inflating bag inside.

People skilled in art should know that, the above types of the air bag packaging arrangement 100′ are not limitations to the content and range of the present invention, and in practice, it is able to be coordinated with various suitable air bag packaging arrangement 100′ according to different needs, and designs the air bag packaging arrangement 100′ with different size and shape according to different needs.

It is worth to mention that, each air bag packaging arrangement 100′ is able to be individually stored in the storage unit 21′, and the storage unit 21′ has many individual chamber to respectively store different air bag packaging arrangement 100′ with different types or different specifications, wherein when it is used, the allocation unit 24′ shall provide the consumer with the selected air bag packaging arrangement 100′. As shown in FIG. 22A, ones stored in the storage unit 21′ are one or more air bag packaging continuums 1000′, wherein the air bag packaging continuum 1000′ comprises many air bag packaging arrangements 100′, such as the above air bag packaging arrangement 100′, 100a′, . . . 199j′ or other air bag packaging arrangements, wherein an easy break connection is formed between the adjacent air bag packaging arrangement 100′ so that when the allocation unit 24′ transfers the air bag packaging arrangement 100′ to the shipment opening 2222′, the buyer can tear off the air bag packaging arrangement 100′ easily for packaging products which are ready for being packaged. It is worth to mention that, such as in this embodiment, the storage unit 21′ is able to store many rolls of the air bag packaging continuums 100′, and the types and specifications of the air bag packaging arrangement 100′ corresponding to each of the air bag packaging continuums 1000′ may be the same of different.

As shown in FIG. 22B, each of the air packaging continuums 1000′ may be not apparently divided into a plurality of air bag packaging arrangements 100′ like FIG. 22A, but be able to be divided according to needs. In other words, when the buyer has selected the air bag packaging arrangement 100′ of suitable size, the allocation unit 23′ shall further comprises a cutting device such that the air bag packaging continuums 1000′ is rolled on the reel for storing, and the processor 222′ correspondingly computes the required cutting location, such as according to the rolling speed of the reel, the radius of the rolled air bag packaging continuums 1000′ and the thickness of a layer of the air bag packaging continuums 1000′ to determine the cutting location, so as to cut a suitable section of the air bag packaging continuums 1000′ which has a suitable size to provide it to the consumer. Herein, the section of the air bag packaging continuum 1000′ is treated as an air bag packaging arrangement 100′ to provide to the consumer. The section of the air bag packaging continuum 1000′ is able to be coordinated with other packaging materials such as packaging box, packaging case, etc., to provide buffering effect.

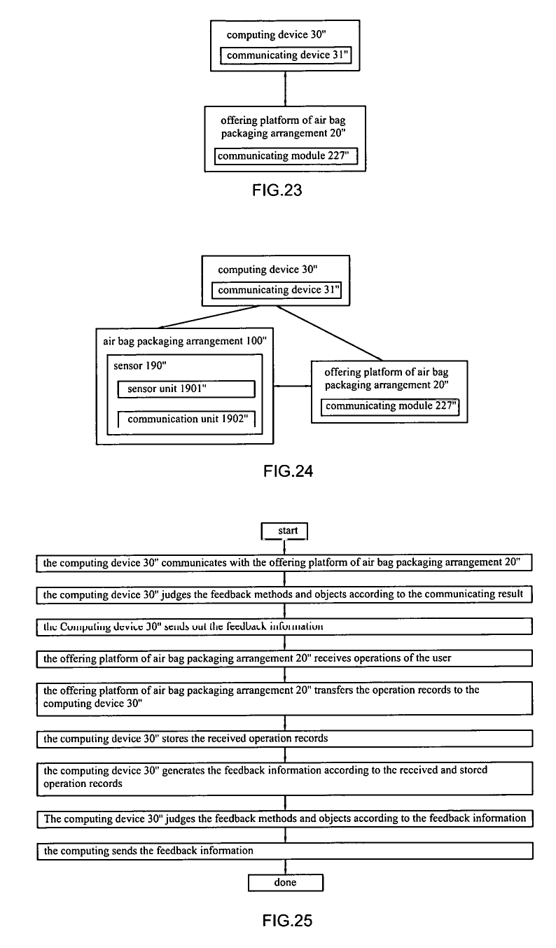

As shown in FIG. 23, a monitoring system of the offering platform of the air bag packaging arrangement of the sixth preferred embodiment according to the present invention is illustrated, wherein the monitoring system comprises a computing device 30″ adapted for storing and analyzing the related information and data, and at least a offering platform of the air bag packaging arrangement 20″. The computing device 30″ comprises a communicating device 31″ connected with the computing device 30″ to allow the computing device 30″ to communicate information with the external, wherein the computing device 30″ can be a computer, mobile phone, cloud server, and other computing device. The communicating device 31″ can be an Ethernet adapter, telephone modem, WIFI, GSM communicating device, CDMA communicating device, blue-tooth communicating device, Radio Transceiver device, SATCOM device, or other device having one or more proximal and remote communication capabilities.

The offering platform of the air bag packaging arrangement 20″ comprises a communicating module 227″ connected with it so as to allow the offering platform 20″ of the air bag packaging arrangement to communicate with the outside, wherein the communicating module 227″ can be an Ethernet adapter, telephone modem, WIFI, GSM communicating device, CDMA communicating device, blue-tooth communicating device, Radio Transceiver device, SATCOM device, or other devices having one or more proximal and remote communication capabilities. It is worth to mention that, the communicating module 27″ in a particular embodiment and in accordance with certain conditions, adopts a communication unit which is same with the communicating device 31″, for example the both have the matched blue-tooth communication units and the practical location is in the signal range, and in other conditions, adopts different communication units and indirect online, for example, one of them is a GSM communication device, another is Ethernet adapter, and each of them converts signals through services provided by the telecom operator, and then directly or through the internet connect the device, or one of them is a GSM communication device, and another is a wireless network module, both of which can converts signals through services provided by the telecom operator, and use the wireless network card terminal disposed therein through the wireless network signal conversion service provided by the telecom operator or the third-party to achieve the connecting aims. In other words, although the communication device 31″ and the communicating module 227″ in one embodiment of the present invention must match with each other in some way to achieve the aim of connection, in practice, they are not limited to using the same devices, and are also not limited to directly connecting or through a third-party to achieve the connection. In other words, the present invention comprises all the ways that make the both to achieve the communications.

In addition, the communicating device 31″ and the communicating module 227′ of the present invention comprise at least one communication device or one module, and derive a variety of connecting ways. For example, both of them can simultaneously have Ethernet module and wireless network module, which can communicate with each other through two ways and through the link aggregation to increase the bandwidth, and the two communicating ways can also be mutually redundant or debugging data. Or, for example, the communicating device 31″ can have both blue-tooth and wireless network module, and simultaneously connect the wireless network module with the remote offering platform of the fluid bag packaging arrangement 20″ through the internet. In other words, if the computing device 30″ communicates with a plurality of offering platforms of the fluid bag packaging arrangement 20″, the implementing ways can be merged for using or respectively be used. Except that, in some embodiments, the communicating device 31″ and the communicating module 227″ only need to be connected with each other, and each of them can have a module which is directly or indirectly connected with the internet, or don't have a module which is directly or indirectly connected with the internet. Appositively, in some embodiments, at least one of the communicating device 31″ and the communicating module 227″ must have a module which is directly or indirectly connected with the internet or other external network so as to be connected with each other to get related information and commands from the internet or the external network. Herein, the external network is a group of devices which is in the monitoring system of the offering platform of the fluid bag packaging arrangement of the present invention such as any network including the internet, except the network which is formed between the computing device 30″ and some offering platform 20″ of fluid bag packaging arrangements 20″, and other external network is the external network except the internet, such as an internal network in a shopping mall or a factory, another group of network formed by the monitoring system of the offering platform of the fluid bag packaging arrangement of the present invention, a data exchanging network operated by the telecom company, and an indoor telephone network formed by a telephone switchboard.

The offering platform of the fluid bag packaging arrangement 20″ is mainly used to directly or indirectly provided and/or fill a certain number and type of fluid bag packaging arrangement 100″ after receiving the particular commands or information. In different embodiments, the offering platform of the fluid bag packaging arrangement 20″ can be a semi-self-help offering machine of the fluid bag packaging arrangement, a vending device of air bag packaging arrangement, a working station of the air bag packaging arrangement, a working station of special air and fluid bag packaging arrangement, or other offering platform of the fluid bag packaging arrangement based on the same or similar principles. It is worth to mention that, when it is embodied as a semi-self-help offering machine of the fluid bag packaging arrangement, the fluid bag packaging arrangement provided by the offering platform of the fluid bag packaging arrangement 20″ can be got under the assistance of the worker or by self

The offering platform of the fluid bag packaging arrangement 20″ also can comprise a storage unit 21″, a controlling unit 22″, a fluid filling device 23″, an allocation unit 24″ and other possible components. According to different methods, the storage unit 21″, the controlling unit 22′, and the fluid filling device 23″ are respectively performed individual device so as to be separate from the offering platform of the fluid bag packaging arrangement 20″ for that after getting the fluid bag packaging arrangement 100″ from the offering platform of the fluid bag packaging arrangement, the user uses the fluid filling device 23″ to inflate the fluid bag packaging arrangement 100″. That is to say, the user or other assistant workers can manually use the fluid filling device 23″ later, such as pump, storage groove, high-pressure inflator, or other device that can charge the fluid material, or the combination of the similar devices to fill the fluid bag packaging arrangement 100″ with the fluid materials. Except that, the fluid filling device 23″, the storage unit 21″ and the controlling unit 22″ can be integrated in the offering platform of the fluid bag packaging arrangement 20″ which shall allow the user directly gets the fluid bag packaging arrangement 100″ which has been filled with fluid materials.

Specifically speaking, the storage unit 21″ is used to store various fluid bag packaging arrangements 100″ including but not limited to the fluid bag packaging arrangement 100″ which have different model, size. In some embodiments, the variety of the fluid bag packaging arrangements 100′ are also able to be stored in the storage unit 21″ for displaying. In other words, the consumer can see the various fluid bag packaging arrangements 100″ stored in the storage unit 21″ form the outside of the offering platform of the fluid bag packaging arrangement 20″. The controlling unit 22″ is used to assist the consumer to select the fluid bag packaging arrangement 100″ and verify the authority of the user during the process, and in the subsequent usage process, the controlling unit 22″ is able to control the inflating device 23″ to complete the operation of inflating the fluid bag packaging arrangement 100″ which are selected and paid for, so that the user can get the fluid bag packaging arrangement 100″ which has been inflated finally. Except that, in some embodiments, the controlling unit 22′ can be used to assist to receive the input of the information and the output of the information, provide receipt, make sounds and signals, and other applied methods.

Further specially speaking, the controlling unit 22″ comprises an input module 221″ and a verifying module 222″, wherein the consumer is able to select the type of the fluid bag packaging arrangement 100″ by the input module 221″. Correspondingly, the user is granted authority to get the selected fluid bag packaging arrangement 100″ through the verifying module 222″ so that the inflating operation and/or other operations such as data acquisition are completed through the fluid verifying device 23″ subsequently.

Specifically, the input module 221″ is able to be embodied to be selection buttons, input keyboard, voice input, eye moving input, motion controlling input, gesture input, touch screen, and other devices providing input methods. The verifying module 222′ is able to be embodied to include various payment methods or their combinations, such as paper money or coin delivery and identification devices, credit card equipment to allow the user to complete the payment and the purchasement, and after completing the payment, the user is granted authority to get the selected fluid bag packaging arrangement 100″ and/or the fluid inflating service. The verifying module 222″ is able to be embodied as a verifying device through the third-party, such as through connecting the communicating module 227″ with a servicer of a third party to confirm the particular members, time, or location, which is allowed to get the particular fluid bag packaging arrangement 100″ and/or the fluid inflating service or not. Specifically, for example, after a user completing the order and swiping a bank card through the official mobile APP or official website, the official APP or the official website is able to provide the information of the verifying order for the verifying module 222″ directly or through its verifying servicer so that the user is granted authority to get the fluid bag packaging arrangement 100″ and/or the fluid inflating service in this condition. The verifying module 222″ is also able to be embodied to be a proximal or single authorization verification device, such as after detecting a particular identifying chip through a detecting module 226″, granting the chip holder the authority to get a particular type and amount of the fluid bag packaging arrangement 100″, or after the user inputting a password through the input module 221″, granting the user the authority to get inflating filling service of a particular type and amount. The controlling unit 22″ comprises a processor 223″, wherein the input module 221″ and the verifying module 222″ are respectively and operatively connected with the processor 223″, and the allocation unit 24″ and the inflating device 23″ are also able to be operatively connected with the processor 223″. In other words, when the allocation unit 24″ receives commends from the processor 223″, the allocation unit 24″ is able to execute the allocating operation so as to provide the selected fluid bag packaging arrangement 100″ to the consumer, wherein when the inflating device 23″ receives commands from the processor 223″, the inflating device 23″ is able to execute the inflating operation so as to inflate the selected fluid bag packaging arrangement 200″ and there is no necessary administrative subordination relationship or necessary order between them. In other words, the offering platform of the fluid bag packaging arrangement 20″ is able to merely provide the fluid bag packaging arrangement 20″ which is not filled fluid materials to the user, merely execute the inflating operation, fill the fluid materials first and then provide it to the user, provide the user with the fluid bag packaging arrangement 100″ which is not filled yet and then assist the user to execute the inflating operation of the fluid bag packaging arrangement 100″, or the combination of the above methods.

The controlling unit 22″ further comprises an output module 225″ which is operatively connected with the processor 223″ to assist the processor 223″ to provide a multi-feedback except the displaying module 224″ to the user. The displaying module 224″ and the output module 225″are able to provide the feedback individually or respectively. For example, when the verifying module 222″ successfully grants authority to the user to get the fluid bag packaging arrangement 100″, the processor 223″ is able to respectively invoke at least one of the displaying module 224″ and the output module 225″ to indicate that the user is successfully granted authority. Herein, the output module 225″ is able to be embodied as a printer, a label machine, a magnetic card or chip reader, audio device, vibrator, token or chip supply device, information generating device, light emitting device, other devices having functions of indicating or providing a certificate, or a combination of the above devices.

The fluid filling device 23″ is operatively connected with the processor 223″, wherein the offering platform of the fluid bag packaging arrangement 20″ sets up a predetermined filling amount of the fluid according to the fluid bag packaging arrangement 100″ of different types and specifications so that the processor 223″ is able to determine whether the filling is completed according to controlling the filling time. Certainly, it also can be users or other workers determine whether the filling is completed and close the corresponding switches. Some fluid bag packaging arrangement 100″ allow to fill fluid of different types and amounts, such as but not limited to two types of gases with fixed volume but different proportions, different volumes of nitrogen in a certain range, less air fixing a little water with color, and so on. In this condition, the user commonly need to complete the selection through the displaying module 221″ in advance, and may need through the verifying of the verifying module 222″ to execute the non-predetermined or personalized fluid filling operations.

It is worth to mention that, the offering platform of the fluid bag packaging arrangement 20″ can be configured with many predetermined programs according to products of different types and their combinations. That is according to these combinations to configure with fluid bag packaging arrangement 100″ of predetermined types and specifications for the user to select. Certainly, different fluid bag packaging arrangement 100″ may have different prices, and need different authority, or have other matters needing attention, so that when provide the user with various selections, it can provide the price, information of authority, and other matters needing attention or advised matters to the user.

The allocation unit 24″ can be various suitable structures, such as lifting platform, to transfer the selected fluid bag packaging arrangement 100″ out of the offering platform of the fluid bag packaging arrangement 20″, or other switches, such as opening a bottom wall of the storage room of the fluid bag packaging arrangement 100″ so that the fluid bag packaging arrangement 100″ shall drop out or slide down by itself, and when the remaining amount of the fluid bag packaging arrangement 100″ in the storage room reaches a certain number, it shall generate an indicating information, or at the same time through the displaying module 224″, the output module 225″, and/or the communicating module 227″ send the supply information or receipt, such as through the communicating module 227″ to order the required types and numbers of the fluid bag packaging arrangements 100″ and the supply service from the factories of the fluid bag packaging arrangements 100″, and such as through the displaying module 224″ to display the indicating information that the fluid bag packaging arrangements 100″ is not enough to remind workers of stores that rent the offering platform of the fluid bag packaging arrangement 20″ and through the output module 225″ to print a two-dimensional bar code receipt which contains the related information of the types and amount of the required fluid bag packaging arrangement 100″ and the verifying information so as to allow the workers of the store hold the two-dimensional bar code receipt to the offering station nearby, and through scanning the two-dimensional bar code receipt to get the required fluid bag packaging arrangement 100″ for supplying, wherein this particular method is especially suitable for a situation that a larger shopping mall has many stores that rent or buy the offering platform of the fluid bag packaging arrangement 20″.

People skilled in art should know that, types of the above described offering platform of the fluid bag packaging arrangement 20″ and modules it contains are not a limitation to the content and range of the present invention. In practice, it is able to be configured with various and suitable fluid bag packaging arrangement 20″ and modules it contains according to needs, and different types and amounts of modules contained in the fluid bag packaging arrangement 20″ can be designed to meet different needs. The most important is that, the offering platform of the fluid bag packaging arrangement 20″ of the present invention can be embodied as a device having a computing device 30″ or a device instead of the computing device 30″, and it contains but not limits to use the controlling unit 22″ as the computing device 30″, and use the communicating module 227″ as the communicating device 31″. In different embodiments, because of the different needs, for example, individually setting a monitoring center terminal as the computing device 30″, and monitoring and linking three vending devices of the air bag packaging arrangement as the fluid supply device packaging platforms 20″, and when the monitoring center terminal is out of work or being repaired, it shall change a vending device of the air bag packaging arrangement to be the offering platform of the fluid bag packaging arrangement 20″ and the computing device 30″, and at the same time, the vending device monitors itself and the three offering platforms of the fluid bag packaging arrangement 20″, or in order to reduce a burden of the device, enhance the efficiency, and consider the costs, the vending device of the air bag packaging arrangement is able to be adjusted as the computing device 30″, and suspends to execute functions of the offering platform of fluid bag packaging arrangement 20″. Furthermore, more than one offering platform of the fluid bag packaging arrangements 20″ are able to cooperate with each other to for the computing device 30″. For example, a factory has four working stations as offering platform of the fluid bag packaging arrangement 20″, wherein one of them has a controlling unit 22″ functioned as a high performance computer, but for some reasons, it is configure with an Ethernet network adapter as the communicating module 227″ and uses a RJ-45 network cable to connect with the controlling unit 22″, but the communicating module 227″ has the working station of the air bag packaging arrangement of the Ethernet network adapter and the blue-tooth communicating device so that is able to through the blue-tooth to communicate the third and the fourth working station of the air bag packaging arrangement. So that, it can use the controlling unit 22″ of the first high performance computer to simultaneously function as the computing device 30″, and unites the communicating module 227″ of the working station of the second air bag packaging arrangement to simultaneously function as the communicating device 31″ to simultaneously monitor four working stations of the air bag packaging arrangement. Except that, these methods can derive to be that the offering platform of the fluid bag packaging arrangement 20″, which simultaneously function as many computing devices 30″, form a vertical or a dependent relationship to achieve the effects of the single-point monitoring and multi-point monitoring through the cascade, parallel, or network manner way. For example, in the above examples, the working stations of the third air bag packaging arrangement and the fourth air bag packaging arrangement are changed to be monitored by the working station of the second air bag packaging arrangement of the second communicating module 227″, which simultaneously has the blue-tooth device, and the working station of the second air bag packaging arrangement and the working station of the first air bag packaging arrangement which has a high performance computer, both of which are parts of the offering platform of the air bag packaging arrangement, are monitored by the working station of the first air bag packaging arrangement and another computing device 30″, and at the same time, the concurrent computing device 30″ of the working station of the first air bag packaging arrangement also can use the Ethernet network adapter as the communicating device 31″ to monitor more other offering platforms of the fluid bag packaging arrangement 20″ which are connected with the internet. The dependent relation is able to be embodied according to the above examples, wherein the first working station of the air bag packaging arrangement is able totally or partially monitors the third and the fourth working station of the air bag packaging arrangement through the second working station of the air bag packaging arrangement. For example, ordinarily, the third and the fourth working station of the air bag packaging arrangement are monitored by the second working station of the air bag packaging arrangement, but when the first working station of the air bag packaging arrangement receives commands form the internet, it shall take over the monitoring of the third and the fourth working stations of the air bag packaging arrangement, or send a one-time command to them, or read their past monitoring data by the second working station of the air bag packing arrangement.

In other embodiments, the computing device 30″ can be replaced by different offering platforms 20″ of the fluid bag packaging arrangement. For example, many offering platforms 20″ of the fluid bag packaging arrangement are respectively vending device of the air bag packaging arrangement in some shopping malls, and working stations of the air bag packaging arrangement in some factories, wherein the using amount of the air bag packaging arrangements of the shopping malls in day time is very large, and the vending device has a high load, so that one of the working stations in the factories can operate as the computing device 30″, and at night, when the shopping mall is out of work, the factories are still in work, so that the working station that operates as the computing device 30″ in the factory shall handover the operation of the computing device 30″ to the vending device of the air bag packaging arrangement in the shopping mall until the shopping mall opening to work in day time or handover the operation to another working station of the air bag packaging arrangement.

People skilled in art should understand that, the above descriptions are only examples of the present invention, and not a limitation to the content and range of the present invention, and in practice, it can be adjusted and changed based on the same or the similar principles.

As shown in FIG. 24, a monitoring system of the offering platform of the fluid bag packaging arrangement of the seventh preferred embodiment according to the present invention is illustrated, wherein the monitoring system comprises a fluid bag packaging arrangement 100′ comprising at least a sensor 190″, wherein the sensor 190″ comprises a sensor unit 1901″ and a communicating unit 1902″. The communicating unit 1902″ can be a wireless network module, GSM communication module, CDMA communicating module, blue-tooth communicating module, radio communicating module, satellite module, or other one or more modules which have wireless communicating functions and are able to operate individually. In addition, considering the costs and the endurance, the communicating unit 1902″ is able to be embodied as one of the above modules, or other one-way signal sending modules, or the combinations of many communicating modules, and in particular condition, only if the starting signals are received, that the one-way or two-way communication is started. Except that the communicating unit 1902″ doesn't adopt the wired communicating methods, the communicating methods that it communicates with the communicating device 31″ and the communicating module 227″ are not limited to using the same communicating unit, certain communicating method, direct communication, or one to one communication. For example, the communicating device 31″ is able to have a blue-tooth module, a wireless network module, and a Ethernet network card, and all of them respectively use the Ethernet network card to communicate with an offering platform of the fluid bag packaging arrangement 20″, and use the blue-tooth to communicate with a close fluid bag packaging arrangement 100″, and use the wireless network module to communicate with another middle-distanced fluid bag packaging arrangement 100″, and the link with the fluid bag packaging arrangement 100″ shall be sent to the wireless network module so as to make the wireless network simultaneously communicate the two middle-distanced fluid bag packaging arrangement 100″. It is worth to mention that, the communicating device 31″, the communicating module 227″ and the communicating unit 1902″ are able to be embodied to be signal relay stations so as to enhance the link intensity, efficiency, and flexibility of the monitoring system of the offering platform of the fluid bag packaging arrangement of the present invention. For example, a fluid bag packaging arrangement 100″ is able to connect with an offering platform of the fluid bag packaging arrangement 20″nearby, and send the information to the computing device 30″ through the connection between the offering platform of the fluid bag packaging arrangement 20″and the computing device 30″, which not only enhances the link efficiency but also provides more link choices, and make the use of the present invention be more flexible. Considering the above examples, when the fluid bag packaging arrangement 100″ transfers the data to the monitoring system of the offering platform of the fluid bag packaging arrangement, for that it doesn't use the third-party service such as 4G LTE communicating network, it shall avoid the extra fees. It is worth to mention that, except the communicating function, the communicating unit 1902″can have light, voice, vibration, or other units having prompting function so as to send the prompt instantly. For example, when the communicating unit 1902″ receives the alarming information, a light signal is sent to remind the holder of the fluid bag packaging arrangement and the people around.

The sensor unit 1901″ can be a temperature sensing unit, a pressure sensing unit, a vibration sensing unit, gyroscope, positioning module, camera module, radio module, light sensing unit, chemical sensing unit, humidity sensing unit, electromagnetic sensing unit, signal sensing unit, module with other sensing function, and the sensing device which are combined by more than one sensing units, wherein the positioning module comprises one or more kinds of satellite positioning system modules, such as satellite positioning system module adapted for the Beidou satellite navigation system, global positioning system of United States, GLONASS system of Russian, and Galileo positioning system of European Union, and other auxiliary global positioning system module, WIFI positioning module, RFID positioning module or modules having positioning function etc.. As for the signal sensing unit, which includes a radar tracking module, radio tracking module, active and passive RFID, Telecom Paging module, SIM module, USIM module, and other modules which have functions of remote identification etc. In different fluid bag packaging arrangement 100″, it can be embodied to have different types and numbers of sensor units 1901″ so to meet for different needs. For example, the fluid bag packaging arrangement 1901″ adapted for packaging boutique artifacts made of glass is able to be configured with a sensor unit 1901″ which has a pressure sensing unit and a positioning module so as to monitor and record whether the fluid bag packaging arrangement 100″ suffers the high pressure or the impact, and provides a protection against burglars and helps to find lost objects. For example, the fluid bag packaging arrangement 100″ adapted for packaging eggs is able to be configured with a sensor unit 1901″ which has a pressure sensing unit only, or not be configured with sensor unit 1901″. Except that, the fluid bag packaging arrangement 100″ adapted for packaging products which are not to market is able to configured with sensor unit 1901″ which has a RFID signal module to record whether the fluid bag packaging arrangement 100″ is dually delivered to and stored in designated place in time.

As shown in FIG. 25, a managing method of the offering platform of the fluid bag packaging arrangement according to the sixth preferred embodiment of the present invention is illustrated, wherein the managing method comprises the following steps:(A) a computing device 30″ communicating the offering platform of the fluid bag packaging arrangement 20″; (B) the computing device 30″ determining and feeding back a method and an object according to a communicating result; (C) the computing device 30″ sending out the feedback information; (D) an offering platform of the fluid bag packaging arrangement 20″ receiving an operation of a user; (E) the offering platform of the fluid bag packaging arrangement 20″ transmitting the operation records to the computing device 30″; (F) the computing device 30″ storing the received operation records; (G) the computing device 30″ generating feedback information according to the received and stored operation records; (H) the computing device 30″ determining the feedback method and objects according to the feedback information; (I) the computing device 30″ sending out the feedback information. Specifically, the step (A) to step(C) are embodied as that when the computing device 30″ is started, it sends connecting requests to many offering platforms of the fluid bag packaging arrangement 20″ through the internet or other connect way, at the same time, if some offering platforms of the fluid bag packaging arrangement 20″ are not able to be connected or false information are transmitted therefrom, the computing device 30″ shall make a judgment according to these communicating results such that “inform staffs of the store where the offering platform of the fluid bag packaging arrangement 20″ placed ″ to check whether the offering platform of the fluid bag packaging arrangement 20″ operates normally” and “in needs to report to a head office the connecting conditions”, etc., and then further executes actions such as “send short messages to the store staffs” and “automatically send emails to persons who in charge of the company”. Except that, when the computing device 30″ communicate with offering platforms of the fluid bag packaging arrangement 20″, it is possible that all the offering platforms of the fluid bag packaging arrangement 20″ normally respond to make a connection, at the same time, the computing device 30″ according to the communicating results may determine that “the managing webpages are needed to be updated to shown that the connection is normal”, so as to further execute an operation of sending the information such as “the connection is normal” to the website servicer of the head office, so that people that login the website of the head office to view the real-time state of the offering platforms of the fluid bag packaging arrangement 20″ so as to know that connections of all the offering platforms of the fluid bag packaging arrangement 20″ are normal.

The described step (D) to step (I) are able to be embodied as that when the offering platform of the fluid bag packaging arrangement 20″ receives operations of a user, such as “ after scanning the shopping receipt of the consumer, providing preselecting programs of types and amounts of the fluid bag packaging arrangements 100” which are matched with the purchased products, and the consumer selecting one of the preselecting programs and completing the operation“, and then the offering platform of the fluid bag packaging arrangement 20” shall transmit the operation records such as “ the selection of the consumer”, “the costing time that the consumer makes the decision”, “the costing time that the consumer execute the packaging operation”, “the video during the operating process ” and other related data to the computing device 30″, and when the computing device 30″ records the received data, it shall determine that what feedback information is required to be generated and which objects are needed to transmit information to, such that “according to recording data, some types of the fluid bag packaging arrangement 100” shall be exhausted, and is needs to send short messages to the people who responsible for the offering platform of the fluid bag packaging arrangement 20″ to make a supply“, so that the computing device 30” shall send a short message such as “please supply Y Z-typed fluid bag packaging arrangements 100” to the number X offering platform of the fluid bag packaging arrangement 20″ or a command to related people. As for an operation of people supplying the fluid bag packaging arrangement 100″, it belongs to operations of users, which shall be recorded by the offering platform of the fluid bag packaging arrangement 20″ and transmitted to the computing device 30″ so that the computing device 30″ shall record the updating situation and shall know the stock of the various fluid bag packaging arrangements 100″ in the offering platform of the fluid bag packaging arrangement 20″, and then the computing device 30″ shall receive data requests from such as website servicer of the head office through the internet and mobile APP of a user who has managing authority, so as to send the information such as “stock data of various fluid bag packaging arrangements 100” in number X offering platform of the fluid bag packaging arrangement 20″ to respectively send to the website servicer of the head office and mobile APP of a user who has managing authority, so that the real-time stock data of various fluid bag packaging arrangements 100″ in particular offering platform of the fluid bag packaging arrangement 20″ shall be shown on the website of the head office and the mobile phone of a user who has managing authority.

It is worth to mention that, the monitoring system of the offering platform of the fluid bag packaging arrangement 20″ according to the present invention may simultaneously manage various types of the offering platforms of the fluid bag packaging arrangement 20′, which are applied in different occasions, such as the one that disposed in a factory to assist workers to package products, the one that disposed in logistics service company for consumers packaging products by themselves, the one that disposed in shopping mall for buyers packaging products for free, and various types of the fluid bag packaging arrangement 100″ are provided by the offering platform of the fluid bag packaging arrangement 20″, such as the one that has a size which is reluctantly matched with the packaging products, the one that has a thicker thickness, a larger size, and a special appearance, the one that is folded up by a special way, and the one that is configured with extra combinations of various sensors, wherein these different fluid bag packaging arrangements 100″ have different price and selling ways respectively, and finally, when the user makes a selection, the costing time that the user make a decision, and other data that the offering platform of the fluid bag packaging arrangement 20″ can monitor, such as moving condition of the user at that time, the temperature at that time, personal data of the user, places or shopping malls where the offering platform of the fluid bag packaging arrangement 20″ are placed, etc., can be recorded by the monitoring system of the offering platform of the fluid bag packaging arrangement 20″ as variable data for statistical analysis. It is worth to mention that, except recording the above described condition, the monitoring system of the offering platform of the fluid bag packaging arrangement 20″ can simultaneously communicate one more sensor unit 1901″ of the fluid bag packaging arrangements 100″ and records information that transmitted by the sensor unit 1901″ and in addition that there is related external information that the computing device 30″ receives form the external network, and finally these records and external information are stored in the computing device 30″ for the user who is granted authority to obtain, or collected, analyzed, or processed by the computing device and then are transmitted out.

In some embodiments, the computing device 30″ can be a computer, which allows to analyze these data directly therein and output these analyzed results, wherein the output methods include such as directly showing on the monitor, printing and written in the CD or the USB, sent out by email, sending to cloud terminal, etc. Except that, the computing device 30″ also can be embodied as terminal device functions of which are limited, so that it only allows transmit these data out through the internet, and then is used for such as sharing, selling, or analyzing them through other devices, etc.

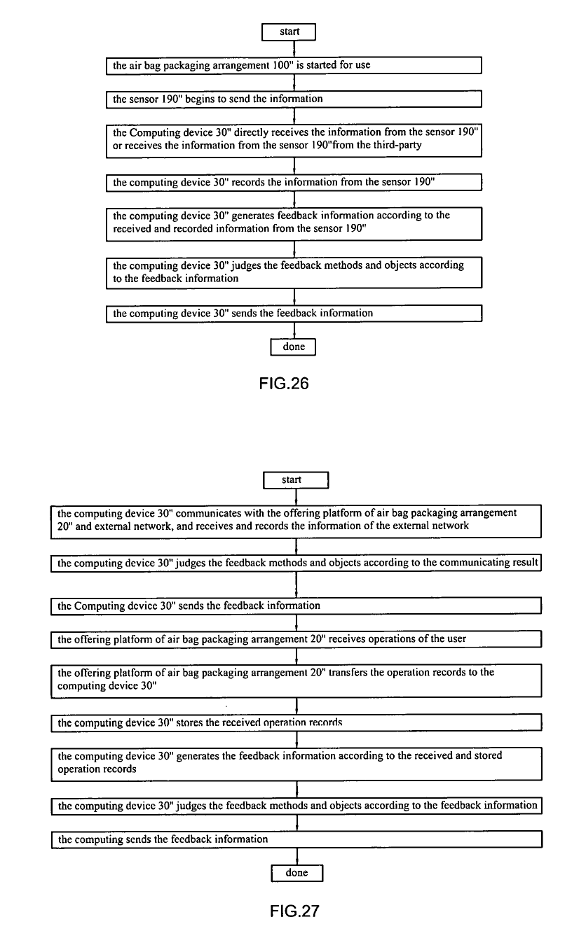

As shown in FIG. 26, a managing method of the offering platform of the fluid bag packaging arrangement according to the seventh preferred embodiment of the present invention is illustrated, wherein the managing method comprises the following steps:(1″) starting the fluid bag packaging arrangement 100″; (2″) a sensor 190″ starting to send information; (3″) a computing device 30″ directly or/and through a third-party receiving the information transmitted from the sensor 190″; (4″) the computing device 30″ recording the information transmitted from the sensor 190″; (5″) the computing generating feedback information according to the received and recorded information which is transmitted from the sensor 190″; (6″) the computing device 30″ determining the feedback method and objects according to feedback information; and (7″) the computing device 30″ transmitting the feedback information out. Specifically speaking, the described method is able to be embodied as that when the fluid bag packaging arrangement 100″ is got and started by a user, the sensor 190″ of the fluid bag packaging arrangement 100″ shall instantly, or meet a certain condition, such as after receiving a remote calling, start to move or send information. For example, a sensor which has a temperature sensing unit shall transmit the detected temperature information through the internet every one minute. After the computing device 30″ receiving the information, it shall make a record and then determines whether transmits the feedback information, feedback methods, and objects, and then send out the feedback information. For example, the computing device 30″ has received a short message that the temperature in the fluid bag packaging arrangement 100″ can't be more than 10 degree, wherein when the information transmitted from the sensor 190″ of the fluid bag packaging arrangement 100″ shows that the temperature it detects in the fluid bag packaging arrangement 100″ is 12 degree, the computing device 30″ shall record the temperature and may make a determination and respectively send reminding short message to the owner that sells products packaged in the fluid bag packaging arrangement 100″ and send command such as “starting the yellow LED signal” to the sensor 190″ of the fluid bag packaging arrangement 100″, and send the corresponding code of this situation to mobile APP of a user who has a managing authority etc., and then execute corresponding operation according to it.

As shown in FIG. 27, a managing method of the offering platform of the fluid bag packaging arrangement according to the eighth preferred embodiment of the present invention is illustrated, wherein the managing method comprises steps illustrated in the sixth preferred embodiment and the following steps: in the step (A), the computing device 30″is able to simultaneously communicate with the external network, and receives and stores external information, such that the computing device 30″ is able to simultaneously connect with the internet and the internal network of the shopping mall, and then receives commands and data from these network, such as climate and temperature in every place, and then store these information so as to allow these information to be added into the step (G) as judgment basis. For example, because of the increased temperature in one place, it shall send commands having adjusting parameters to the offering platform of the fluid bag packaging arrangement 20″ in this place so that the offering platform of the fluid bag packaging arrangement 20″ shall reduce charging amount a little every time. Except that, in the step (B), methods that the computing device 30″ send a feedback information comprises directly displaying and transmitting through a communicating device, and the object that it transmits the feedback information to, comprises a proximal terminal disposed in the computing device 30″, a remote or third-party terminal connected with the computing device through the communicating device, and the offering platform of the fluid bag packaging arrangement 20″. For example, after the computing device 31″ receiving fault information of an offering platform of the fluid bag packaging arrangement 20″, it shall send short message to repairing people through the communicating device 31″, or directly display the fault information on the computing device 30″ so that the workers who are responsible for monitoring the computing device 30″ are able to know that and determine which subsequent actions shall take. For example, they can telephone somebody or ignore it. Except that, it can also send closing command to the offering platform of the fluid bag packaging arrangement 20″ so as to try to close the offering platform of the fluid bag packaging arrangement 20″ which is out of work temporarily. Furthermore, in the step (H), the method that the computing device 30″ sends feedback information comprises directly displaying and transmitting through the communicating device, the object that it transmits the feedback information to comprises a proximal terminal disposed in the computing device 30″, a remote or third-party terminal connected with the computing device through the communicating device, and the offering platform of the fluid bag packaging arrangement 20″. For example, when the computing device 30″ receives the information that the fluid bag packaging arrangement that packages an expensive boutique are stolen, the information shall be displayed on the computing device 30″ so that the worker who is responsible for monitoring the computing device 30″ are able to know that and determine which subsequent actions shall take, such as telephoning the owner, or the computing device 30″ is able to send related information to a computer system of a police office or a computer system of a cooperative security company so as to seek the lost object in the first time, or send related information to the offering platform of the fluid bag packaging arrangement 20″ that packages the purchased boutique to inform the merchant.

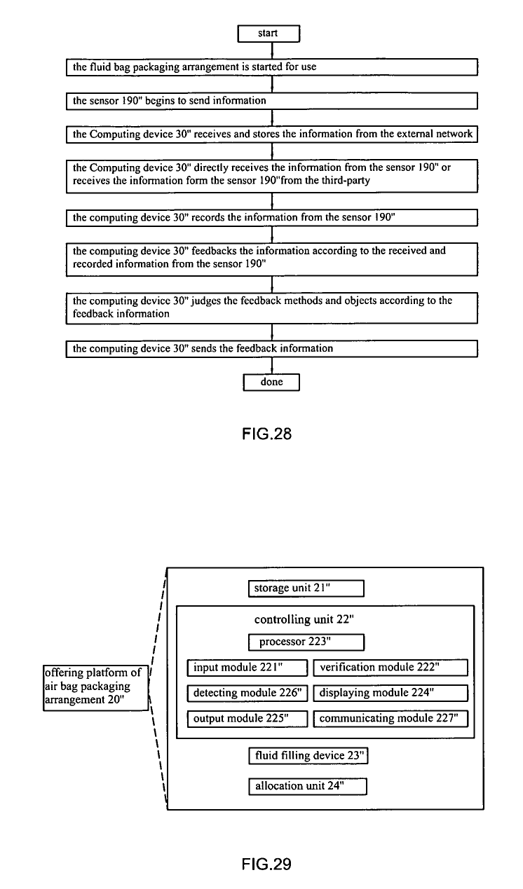

As shown in FIG. 28, a managing method of the offering platform of the fluid bag packaging arrangement according to the ninth preferred embodiment of the present invention is illustrated, wherein the managing method comprises steps illustrated in the seventh preferred embodiment and the following steps: after the step (2″), the computing device 30″ also receives and stores the information form the external network. For example, the computing device 30″ is able to connect with the internet or the internal network in the company, and then receives commands and data from these networks. For example, the climate and temperature information in every place and the latest service regulations of take-out food are stored, and in the step (5″), it allows the computing device 30″ treat this information as decision fundaments. For example, for that the temperature in one place follow down sharply, it shall send information to the information to the offering platform of the fluid bag packaging arrangement 20″ of the take-out food company in this place so that the displaying module 224″ of the fluid bag packaging arrangement 20″ shall display the reminding information to remind the people who send the take-out food speed up to avoid that the temperature of the take-out food is too low when it is reached.

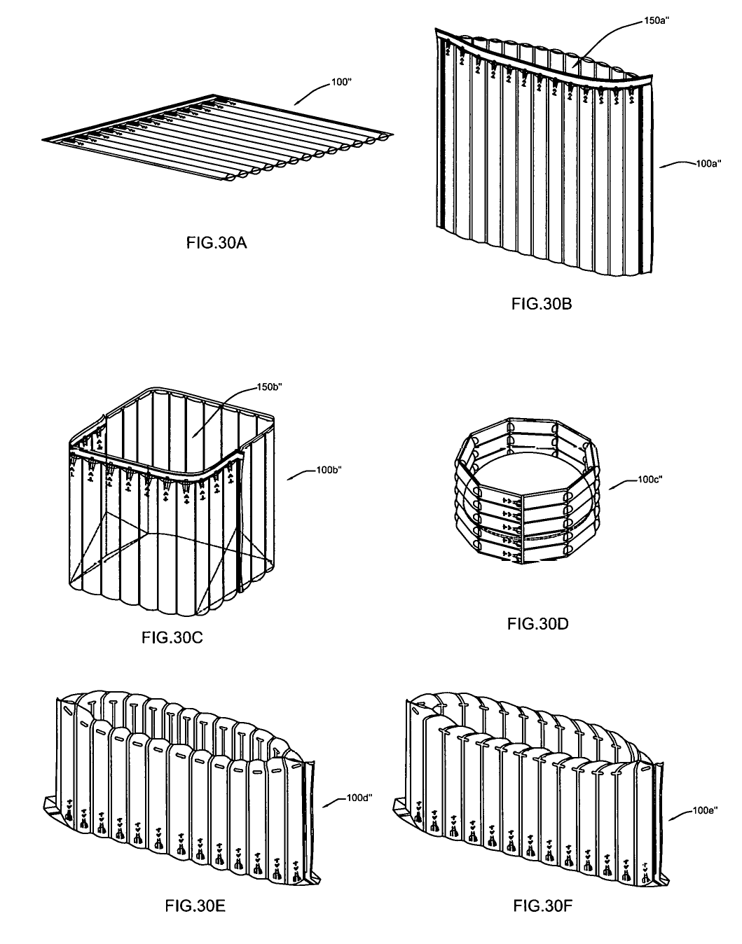

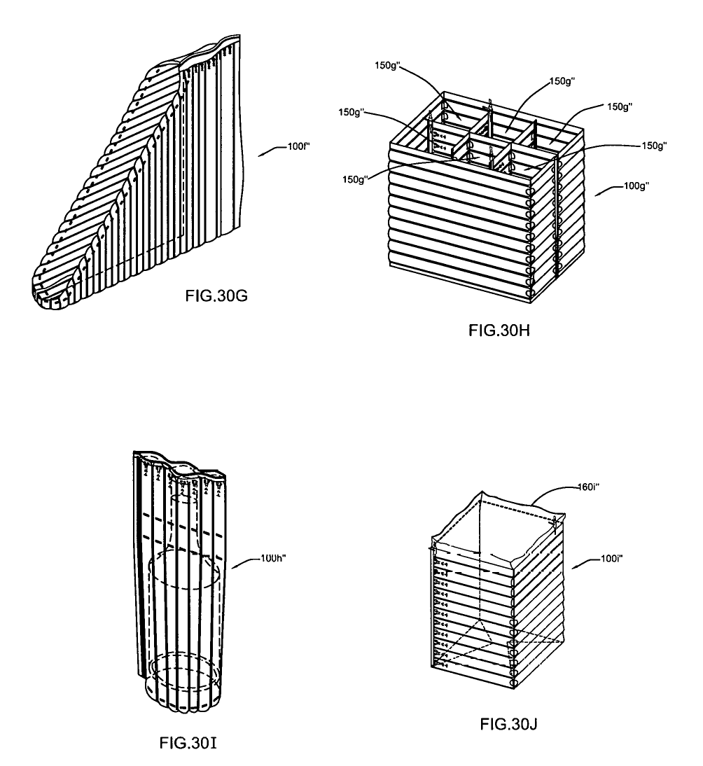

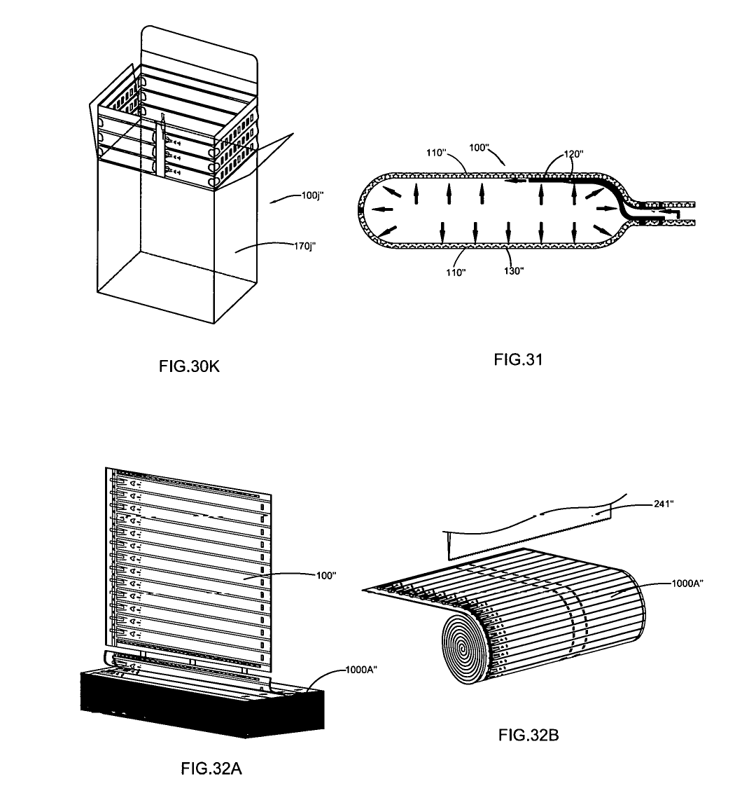

Drawings of FIG. 30A to FIG. 30K illustrate different types of the fluid bag packaging arrangement 100″ according to the present invention. The fluid bag packaging arrangement 100″ mainly provides buffering effect through inflating fluid, wherein the fluid that is inflated therein can be air, particular material, compound gas such as hydrogen, nitrogen, helium, carbon dioxide, etc., specific substances or compounds liquid, such as liquid nitrogen, water, glycerin, organic liquid such as animal and vegetable oils, or a mixture of various gases and/or liquid, wherein different liquid provide different effects. For example, the helium can make the fluid bag packaging arrangement 100″float, and the fluid mixed with liquid nitrogen has cooling effect. It is worth to mention that, the fluid material filled in the fluid bag packaging arrangement 100″ can be 90% gas mixed with 10% color water which make the fluid bag packaging arrangement 100″ presents different color or characters etc.. Except that, in some embodiments, the fluid bag packaging arrangement 100″ further comprises other packaging materials so as to provide extra protecting or buffering effects.

In this preferred embodiments according to the present invention, the fluid bag packaging arrangement 100″ comprises four-layer films which comprise two-layer air chamber films 110″ and two-layer valve films 120″ that form one-way valves, and through a series of heat sealing to form one or more filling units 130″. During the inflation, the fluid passes through the two-layer valve films 120″ into chambers of each of the filling units 130″, and then after inflating enough air in the inflation chambers of the filling units 130″, the pressure in the filling chamber shall be exerted on the two-layer valve films 120″ so as to close the air channel between the two-layer valve films 120″. The filling opening of the air bag packaging arrangement 100″ is able to be inserted into the filling mouth of the filling device 23″ so as to fill the fluid bag packaging arrangement 100″.

As shown in FIG. 30A, the fluid bag packaging arrangement 100″ can be an fluid filling cushion which forms a fluid filling material adapted for being filled in the packaging boxes, packaging cases, or packaging bags after being filled with fluid material to make a buffering function. As shown in FIG. 30B to FIG. 30K, the fluid bag packaging arrangement 100″ form an accommodating chamber through being bent and heat-sealed itself for accommodating the packaging products. Specifically, as shown in FIG. 30B, the fluid bag packaging arrangement 100a″ has many filling side walls for forming the accommodating chamber 150a″, wherein the packaged products are able to be stored in the accommodating chamber 150a″, and the total bag body has a rough U-shape. As shown in FIG. 30C, the fluid bag packaging arrangement 100b″ forms the accommodating chamber 150b″ which has a roughly square shape so as form the square fluid bag packaging arrangement 100b″ to accommodate the packaged products which have a roughly square shape such as various electronic devices and so on. As shown in FIG. 30D, the fluid bag packaging arrangement 100″ has a ring shape, which is able to surround around the packaged products as to form the edge-around packaging arrangement. As shown in FIG. 30E, the fluid bag packaging arrangement 100d″ is able to form multi-layer inflatable structure, such as the filling bag structure formed by overlapping an inner layer with an external layer, to enhance the buffering effect. As shown in FIG. 30F, the filling bag structure which is overlapped by the inner layer and the external layer of the fluid bag packaging arrangement 100e″ is able to be disposed in misplaced arrangement to reduce its thickness. As shown in FIG. 30g″, the filling structure of the fluid bag packaging arrangement 100f″ is in misplaced and overlapped manner to form a rough triangle so as to form an angle packaged arrangement, such as to be used to package four corners of a TV. As shown in FIG. 30h″, the fluid bag packaging arrangement 100g″ forms many sub-cavity 150g″ to store different products. As shown in FIG. 30i″, the fluid bag packaging arrangement 100h″ forms an extended accommodating chamber 100h″, so as to be fit for packaging the extended products such as bottled red wine. As shown in FIG. 30J″, an inner portion of the fluid bag packaging arrangement 100i″ is incorporated with a fixedly connected inner packaging layer 160i″, wherein the packaging layer 160i″ is able to be other functional material, such as waterproof materials, moisture-proof materials, heat-insulated materials, warm-kept materials, shading materials, electrostatic materials, wear-standing materials, printing materials, or the above combinations. Except that, the packaging layer 170j″ is also able to be packaging box, wherein the fluid chamber film of the fluid bag packaging arrangement 100j″ is pasted with an inner portion of the packaging box, and when it is unused, the packaging box is in the folded state, and when the filling unit formed by the fluid chamber film is filling, the folded packaging box is automatically opened so as to form a bag-in-box structure which has the packaging box outside and the filling bag inside.

People skilled in art should know that, the above types of the fluid bag packaging arrangement 100″ are not treat as a limitation to the content and range of the present invention, and in practice, it is able to be coordinated with various suitable fluid bag packaging arrangement 200″ according to different needs, and he fluid bag packaging arrangement 100″ with different size and shape are able to be designed according to different needs.

It is worth to mention that, each fluid bag packaging arrangement 100″ is able to be individually stored in the storage unit 21″, and the storage unit 21″ has many individual chamber to respectively store different fluid bag packaging arrangement 100″ with different types or different specifications, wherein when it is used, the allocation unit 24″ shall provide the user with the selected fluid bag packaging arrangement 100″.

As shown in FIG. 32A, ones stored in the storage unit 21″ are one or more fluid bag packaging continuums 1000″, wherein the fluid bag packaging continuum 1000″ comprises many fluid bag packaging arrangements 100″, such as the above fluid bag packaging arrangement 100″, 100a″, . . . 199j″ or other fluid bag packaging arrangements, wherein an easy break connection is able to be formed between the adjacent fluid bag packaging arrangement 100″ so that when the allocation unit 24″ transfers the fluid bag packaging arrangement 100″ to the shipment opening 2222″, the buyer can tear off the fluid bag packaging arrangement 100″ easily for packaging products which are ready for being packaged. It is worth to mention that, such as in this embodiment, the storage unit 21″ is able to store many rolls of the fluid bag packaging continuums 100″, and the types and specifications of the fluid bag packaging arrangement 100 corresponding to each of the fluid bag packaging continuums 1000″ may be the same of different.

As shown in FIG. 32B, each of the fluid packaging continuums 1000″ may be not apparently divided into a plurality of fluid bag packaging arrangements 100″ like FIG. 32A, but is able to be divided according to needs. In other words, when the buyer has selected the suitable size of the fluid bag packaging arrangement 100″, the allocation unit 24″ shall further comprises a cutting device such that the fluid bag packaging continuums 1000″ is rolled on the reel for storing and the processor 223″ correspondingly computes the cutting location that is required, such as through the rolling speed of the reel, the radius of the rolled fluid bag packaging continuums 1000″ and the thickness of a layer of the fluid bag packaging continuums 1000″ to determine the cutting location, so as to cut a suitable section of the fluid bag packaging continuums 1000″ which has a suitable size to provide it to the consumer. Herein, the section of the fluid bag packaging continuum 1000″ is treated as a fluid bag packaging arrangement 100 to provide to the consumer. The section of the fluid bag packaging continuum 1000″ is able to be coordinated with other packaging materials such as packaging box, packaging case and so on to provide buffering effect.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-92. (canceled)

93. A vending device of air bag packaging arrangement adapted for selling an air bag packaging arrangement, comprising:
a storage unit for storing said air bag packaging arrangement;
a controlling unit which comprises a selection module, a payment module and a processor, wherein said selection module and said payment module are operatively connected with said processor, wherein said selection module is adapted for assisting to select types of said air bag packaging arrangement, and said payment module is adapted for assisting a payment of said selected air bag packaging arrangement; and
an allocation unit operatively connected with said processor and providing said air bag packaging arrangement which is selected and paid to buyers under a controlling of said processor.

94. The vending device of air bag packaging arrangement, as recited in claim 93, further comprising an inflating device for inflating said air bag packaging arrangement which is paid, wherein said inflating device is operatively connected with said processor to respond controlling commands of said processor and inflate said air bag packaging arrangement which is selected and paid, said inflating device automatically completes an inflating operation of said air bag packaging arrangement which is selected and paid through controlling inflating time.

95. The vending device of air bag packaging arrangement, as recited in claim 94, wherein said controlling unit further comprises a scanning module which is operatively connected with said processor, wherein said scanning module is used to scan a paying receipt so as to execute functions of said payment module to complete functions of confirming payment and a shopping list of said buyers for said processor computing and matching said suitable air bag packaging arrangement according to products on said shopping list, wherein said scanning module is a three dimensional scanning device, which scans products purchased by said buyer in three-dimensional manner for said processor computing and matching said suitable air bag packaging arrangement for said products according to scanning information

96. The vending device of air bag packaging arrangement, as recited in claim 94, wherein said controlling unit further comprises a communicating module operatively connected with said processor to assistant to complete a function of a third-party payment, and after said payment being completed, said communicating module receives an information of confirming to pay from said third-party payment platform and transmits said payment information to said processor, wherein said payment module provides a scanning identity and said buyer use an electronic mobile device to scan said scanning identity so as to start payment function.

97. The vending device of air bag packaging arrangement, as recited in claim 94, wherein said allocation unit further comprises a cutting portion to cut an air bag packaging continuum which forms said air bag packaging arrangement at a suitable portion to form said air bag packaging arrangement having suitable size and shape.

98. A method of automatically selling an air bag packaging arrangement through a vending machine, comprising the following steps:
receiving a purchasing command from a buyer and assisting said buyer to completing selection of types and payment of said air bag packaging arrangement; and
providing said selected and paid air bag packaging arrangement to said buyer through an allocation unit.

99. The method, as recited in claim 98, further comprising the steps of:
inflating said selected and paid air bag packaging arrangement through a inflating device which is integrally disposed in said vending device;
inflating said air bag packaging arrangement first and then packaging products with said inflated air bag packaging arrangement, or packaging products first with an air bag packaging arrangement which is not inflated and then inflating said air bag packaging arrangement.

100. The method as recited in claim 99, wherein said inflating of said various air bag packaging arrangement is controlled through an inflating time.

101. The method as recited in claim 100, further comprising the steps of:
receiving information of types and sizes of said products ready for being packaged that said buyer inputting;
after a computing and matching operation, providing preselecting programs of said air bag packaging arrangement used to package products ready for being packaged to said buyers for said buyer selecting; and
after confirming said payment to be completed, directly providing said matched air bag packaging arrangement to said buyers.

102. The method as recited in claim 100, further comprising the steps of:
scanning said products ready for being packaged of said buyer in three-dimensional manner;
after a computing and matching operation, providing preselecting programs of said air bag packaging arrangement used to package products ready for being packaged to said buyers for said buyer selecting; and
after confirming said payment to be completed, directly providing said matched air bag packaging arrangement to said buyers.

103. The method as recited in claim 100, wherein said air bag packaging arrangement comprises two-layer air chamber films and two-layer valve films, wherein said two-layer air chamber films and said two-layer valve films are overlapped with each other to form a one-way valve for inflating one or more inflating units formed by said two-layer air chamber films, wherein said air bag packaging arrangement comprises an inflation cushion which functions as an inflation material to be filled in other packaging boxes, or packaging bags and an air packaging bag having an accommodating chamber, which is formed by being folded up and heat sealed, wherein said products are adapted for being disposed in said accommodating chamber.

104. A working station of air bag packaging, comprising:
a storage unit for storing many said air bag packaging arrangements;
a controlling unit which comprises a selection module and a processor, wherein said processor is connected with said storing unit and said selection unit to make a worker select corresponding air bag packaging arrangement according to needs;
an allocation unit connected with said processor and said storage unit to execute commands of said processor to allocate said corresponding air bag packaging arrangement to said worker; and
an inflating unit connected with said allocation unit and said processor to execute commands of said processor to inflate said corresponding air bag packaging arrangement.

105. The working station, as recited in claim 104, wherein said controlling unit further comprises a scanning module which is connected with said processor to feedback scanning information to said processor for said processor sending commands.

106. The working station, as recited in claim 105, further comprising a supporting unit and a transferring unit, wherein said supporting unit is operatively connected with said allocation unit, said inflating unit and said processor to execute commands of said processor to open said air bag packaging arrangement to package products, wherein said transferring unit is operatively connected with said supporting unit and said processor to execute commands of said processor to transfer said air bag packaging arrangement which has packaged products, wherein said supporting unit is adapted for connecting with a shipment machine to package said products transferred out by said shipment machine, wherein said inflating unit is connected with said supporting unit and said allocation unit to inflate and open said allocated air bag packaging arrangement to package said products.

107. The working station, as recited in claim 104, further comprising:
a computing device for storing and analyzing information and data, wherein said computing device comprises a communicating device which is operatively connected with said computing device to allow said computing device to communicate with external information; and
at least an offering platform of fluid bag packaging arrangement which comprises a controlling unit comprising an input module, a verifying module, a communicating module, and a processor, wherein said input module, said verifying module and communicating module are respectively and operatively connected with said processor, wherein said input module is used to assistant to select types of said fluid bag packaging arrangement, and said verifying module is used to assistant to complete an authority to said selected fluid bag packaging arrangement, and said communicating module allows said offering platform of fluid bag packaging arrangement to communicate with external information and said computing device.

108. The working station, as recited in claim 107, further comprising a fluid bag packaging arrangement, wherein said fluid bag packaging arrangement comprises an allocation unit operatively connected with said processor and provides said fluid bag packaging arrangement which is selected and granted authority under a controlling of said processor, wherein said verifying module provides one or more devices selected from proximal payment device, remote payment device, receipt recognition device to communicate external information through said communication module, wherein said offering platform of fluid bag packaging arrangement further comprises a storage unit to store said fluid bag packaging arrangement therein and a fluid filling device for filling said fluid bag packaging arrangement which is granted authority.

109. The working station, as recited in claim 108, wherein said fluid filling device is operatively connected with said processor to respond commands of said processor to inflate said fluid bag packaging arrangement which is selected and granted authority, wherein said controlling unit further comprises a displaying module which is operatively connected with said processor to display information, an output module which is operatively connected with said processor to output information, and a detecting module which is operatively connected with said processor to output information.

110. The working station, as recited in claim 108, wherein said offering platform of fluid bag packaging arrangement matches said fluid bag packaging arrangement which is suitable for said user's need through said processor recognizing information which is inputted through said input module by said user, wherein through said processor recognizing information which is inputted through said input module by said user, said offering platform of fluid bag packaging arrangement receives corresponding data through said communicating module to match said fluid bag packaging arrangement which is suitable for said user's need, wherein said offering platform of fluid bag packaging arrangement identifying products through said detecting module detecting information for said processor matching suitable fluid bag packaging arrangement.

111. The working station, as recited in claim 108, wherein said allocation unit further comprises a processing device to cut, heat-seal, or extrude a fluid bag packaging continuum at a suitable location formed said fluid bag packaging arrangement to obtain said fluid bag packaging arrangement with suitable size and shape.

112. The working station, as recited in claim 108, further comprising at least a sensor configured with said fluid bag packaging arrangement, wherein said sensor is selected one or more from temperature sensors, pressure sensors, vibration sensors, gyroscope, position sensors, camera modules, radio modules, light sensors, chemical sensors, humidity sensors, electromagnetic sensors, signal sensing units.
